(19) United States
(12) Patent Application Publication
(10) Pub. No.: US 2026/0309908 A1
(43) Pub. Date: Oct. 8, 2026

(54) MULTICORE OPTICAL FIBER

(71) Applicant: CORNING INCORPORATED, CORNING, NY (US)

(72) Inventors: Kevin Wallace Bennett, Hammondsport, NY (US); Douglas Llewellyn Butler, Painted Post, NY (US); Matthew Artus Tuggle, Seattle, WA (US)

(21) Appl. No.: 19/632,900

(22) Filed: Mar. 30, 2026

Related U.S. Application Data
(60) Provisional application No. 63/782,888, filed on Apr. 3, 2025.

(51) Int. Cl. G02B 6/02

(52) U.S. Cl. CPC G02B 6/02042; G02B 6/02004

(57) ABSTRACT

A multicore optical fiber may include a first core element, a second core element, a common cladding surrounding and contacting the first core element and the second core element, and a marker element. The first core element and the second core element may be disposed symmetrically on either side of a reference plane passing through a centerline of the multicore optical fiber and passing through the marker element. The marker element may be disposed asymmetrically about the reference plane.

### CROSS-REFERENCE TO RELATED APPLICATIONS

This application claims the benefit of priority of U.S. Application Ser. No. 63/782,888 filed on Apr. 3, 2025, the content of which is relied upon and incorporated herein by reference in its entirety.

### FIELD OF THE DISCLOSURE

This disclosure pertains to optical fibers. More particularly, this disclosure relates to multicore optical fibers. Most particularly, this disclosure relates to multicore optical fibers having a marker element.

### BACKGROUND OF THE DISCLOSURE

Multicore optical fibers include multiple core elements within a common cladding. This allows for significant improvements regarding total bandwidth within a single optical fiber. Each core element, however, can be identical, necessitating core-element identification (or simply, core identification) when viewed at the cross section, which can be an important consideration regarding optical matching in various span lengths and/or possibly optimizing total span attenuation. Therefore, there is a need for efficient and effective identification of core elements in multicore optical fibers.

### SUMMARY

In some embodiments, a multicore optical fiber, may include: a first core element, a second core element, and a marker element. In some embodiments, the first core element and the second core element may be disposed symmetrically on either side of a reference plane passing through a centerline of the multicore optical fiber and passing through the marker element. In some embodiments, the marker element may be disposed asymmetrically about the reference plane.

In some embodiments, a multicore optical fiber may include: a first end, a second end opposite the first end, a length between the first end and the second end, a first core element extending along the length of the multicore optical fiber from the first end to the second end, a second core element extending along the length of the multicore optical fiber from the first end to the second end, and a marker element. The first end defines a first cross section of the multicore optical fiber, and the second end defines a second cross section of the multicore optical fiber. In some embodiments, the first core element, the second core element, and the marker element may be configured such that when the second cross section may be superimposed on the first cross section with a centerline of a first cross-sectional shape of the first core element from the first cross section being aligned with a centerline of a second cross-sectional shape of the second core element from the second cross section, a third cross-sectional shape of the marker element from the first cross section may partially overlap with and may be offset from a fourth cross-sectional shape of the marker element from the second cross section.

In some embodiments, a multicore optical fiber may include: a first end, a second end opposite the first end, a length between the first end and the second end, a core element extending along the length of the multicore optical fiber from the first end to the second end, a marker element, and a common cladding surrounding and contacting the core element and the marker element. The first end defines a first cross section of the multicore optical fiber, and the second end defines a second cross section of the multicore optical fiber. In some embodiments, the core element and the marker element may be configured such that when the second cross section may be superimposed on the first cross section with a centerline of a first cross-sectional shape of the marker element from the first cross section being aligned with a centerline of a second cross-sectional shape of the marker element from the second cross section, a third cross-sectional shape of the core element from the first cross section may partially overlap with and may be offset from a fourth cross-sectional shape of the core element from the second cross section.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding and are incorporated in and constitute a part of this specification. The drawings are illustrative of selected aspects of the present disclosure, and together with the description serve to explain principles and operation of methods, products, and compositions embraced by the present disclosure.

### BRIEF DESCRIPTION OF THE DRAWINGS

FIG. 1 schematically illustrates a cross-sectional view of a multicore optical fiber having a symmetrical marker element.

FIG. 2 schematically illustrates a length of the multicore optical fiber of FIG. 1.

FIG. 3 schematically illustrates a cross-sectional view of a multicore optical fiber having an asymmetrical marker element.

FIG. 4 schematically illustrates a length of the multicore optical fiber of FIG. 3.

FIG. 5 schematically illustrates a cross-sectional view of a multicore optical fiber having core elements arranged in an offset manner.

FIG. 6 schematically illustrates a cross-sectional view of an example of a multicore optical fiber according to some embodiments.

FIG. 7 schematically illustrates a length of the multicore optical fiber of FIG. 6.

FIG. 8 shows an image formed by superimposing the cross-sectional images of the opposite ends of the length of the multicore optical fiber of FIG. 7.

FIG. 9 schematically illustrates a cross-sectional view, at the location of splice, of two lengths of the multicore optical fiber of FIG. 7, where fiber ends having opposite handedness are spliced together.

FIG. 10 schematically illustrates a cross-sectional view, at the location of splice, of two lengths of the multicore optical fiber of FIG. 7, where fiber ends having the same handedness are spliced together.

FIG. 11A schematically illustrates marker elements of two lengths of the multicore optical fiber of FIG. 7 are aligned to bring the core elements of the two lengths of the multicore optical fiber to close proximity for subsequent fine adjustment for splicing fiber ends of the same handedness together.

FIG. 11B shows another image formed by superimposing the cross-sectional images of the opposite ends of the length of the multicore optical fiber of FIG. 7.

FIG. 12A reproduces the cross-sectional view of the multicore optical fiber of FIG. 6 along with an inset of the marker element.

FIG. 12B reproduces the cross-sectional view of the multicore optical fiber of FIG. 1 along with an inset of the marker element.

FIG. 13A schematically illustrates a cross-sectional view of another example of a multicore optical fiber according to some embodiments.

FIG. 13B schematically illustrates a cross-sectional view of another example of a multicore optical fiber according to some embodiments.

FIG. 14 schematically illustrates a cross-sectional view of another example of a multicore optical fiber according to some embodiments.

FIG. 15 schematically illustrates a cross-sectional view of another example of a multicore optical fiber according to some embodiments.

FIG. 16 schematically illustrates a cross-sectional view of another example of a multicore optical fiber according to some embodiments.

FIG. 17 schematically illustrates a cross-sectional view, at the location of splice, of two lengths of the multicore optical fiber of FIG. 16, where fiber ends having the same handedness are spliced together.

FIG. 18 schematically illustrates a cross-sectional view of another example of a multicore optical fiber according to some embodiments.

FIG. 19 schematically illustrates a cross-sectional view of another example of a multicore optical fiber according to some embodiments.

### DETAILED DESCRIPTION

The present disclosure is provided as an enabling teaching and can be understood more readily by reference to the following description, drawings, examples, and claims. To this end, those skilled in the relevant art will recognize and appreciate that many changes can be made to the various aspects of the embodiments described herein, while still obtaining the beneficial results. It will also be apparent that some of the desired benefits of the present embodiments can be obtained by selecting some of the features without utilizing other features. Accordingly, those who work in the art will recognize that many modifications and adaptations are possible and can even be desirable in certain circumstances and are a part of the present disclosure. Therefore, it is to be understood that this disclosure is not limited to the specific compositions, articles, devices, and methods disclosed unless otherwise specified. It is also to be understood that the terminology used herein is for the purposes of describing particular aspects only and is not intended to be limiting.

In this specification and in the claims which follow, “greater than or equal to” and “≥” are used interchangeably, “less than or equal to” and “≤” are used interchangeably, “greater than” and “>” are used interchangeably, and “less than” and “<” are used interchangeably. When a parameter is described as greater than or equal to (or simply, ≥) a value, the parameter may be greater than (>) the referenced value or equal to (=) the referenced value. Similarly, when a parameter is described as less than or equal to (or simply, ≤) a value, the parameter may be less than (<) the referenced value or equal to (=) the referenced value.

When terms, such as “circular,” “square,” “linear,” “parallel,” “perpendicular,” “tangential,” “symmetrical,” “congruent,” “identical,” “coaxial,” “concentric,” “equiangular,” “equidistant,” etc., are used to describe geometrical properties, it is understood that actual geometrical properties may vary or deviate from these precise conditions due to factors including, but not limited to, manufacturing limitations or tolerances, material properties, environmental conditions, measurement inaccuracies, and so on. Thus, while the terms imply precise geometric properties, practical application acknowledges and permits minor discrepancies.

“Include,” “includes,” “including”, or like terms means encompassing but not limited to, that is, inclusive and not exclusive.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When a value is said to be about or about equal to a certain number, the value is within +10% of the number. For example, a value that is about 10 refers to a value between 9 and 11, inclusive. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The term “about” further references all terms in the range unless otherwise stated. For example, about 1, 2, or 3 is equivalent to about 1, about 2, or about 3, and further comprises from about 1-3, from about 1-2, and from about 2-3. Specific and preferred values disclosed for compositions, components, ingredients, additives, and like aspects, and ranges thereof, are for illustration only; they do not exclude other defined values or other values within defined ranges. The compositions and methods of the disclosure include those having any value or any combination of the values, specific values, more specific values, and preferred values described herein.

The indefinite article “a” or “an” and its corresponding definite article “the” as used herein means at least one, or one or more, unless specified otherwise. The term “plurality” means two or more.

Directional terms as used herein—for example up, down, right, left, front, back, top, bottom—are made only with reference to the figures as drawn and the coordinate axis provided therewith and are not intended to imply absolute orientation.

As used herein, contact refers to direct contact or indirect contact. Direct contact refers to contact in the absence of an intervening material and indirect contact refers to contact through one or more intervening materials. Elements in direct contact touch each other. Elements in indirect contact do not touch each other but do touch an intervening material or series of intervening materials, where the intervening material or at least one of the series of intervening materials touches the other element. Contacting refers to placing two elements in direct or indirect contact. Elements in direct (indirect) contact may be said to directly (indirectly) contact each other.

As used herein, “directly adjacent” means directly contacting and “indirectly adjacent” mean indirectly contacting. The term “adjacent” encompasses elements that are directly or indirectly adjacent to each other.

“Optical fiber” refers to a waveguide having a glass portion surrounded by a coating. The glass portion is referred to herein as a “glass fiber”. The glass fiber of a single-core optical fiber consists of a single core region surrounded by one or more cladding regions, where the single core region and one or more cladding regions function collectively as a waveguide. The glass fiber of a multicore optical fiber includes two or more core elements surrounded by a common cladding, where each core element functions as a waveguide in the multicore optical fiber and each core element consists of a core region surrounded optionally by one or more dedicated cladding regions.

“Radial position”, “radius”, or the radial coordinate “r” refers to radial position relative to the centerline (r=0) of a core element of the multicore optical fiber. Each of the two or more core elements of a multicore optical fiber has a centerline and a separate radial coordinate r. “Radial position”, “radius”, or the radial coordinate “R” refers to radial position relative to the centerline (R=0) of the multicore optical fiber. The multicore optical fiber has a single centerline and a single radial coordinate R. The radial coordinate r is used herein to refer to radial position in the core region and any of the dedicated cladding regions of the core elements described herein. The radial coordinate r or R will be used to refer to radial position in the common cladding described herein.

“Refractive index” refers to the refractive index at a wavelength of 1550 nm unless specified otherwise.

The “refractive index profile” is the relationship between refractive index or relative refractive index and radius. For relative refractive index profiles of core elements depicted herein as having step boundaries between adjacent core and/or cladding regions, normal variations in processing conditions may preclude obtaining sharp step boundaries at the interface of adjacent regions. It is to be understood that although boundaries of refractive index profiles may be depicted herein as step changes in refractive index, the boundaries in practice may be rounded or otherwise deviate from perfect step function characteristics. It is further understood that the value of the relative refractive index may vary with radial position r or R within a core region and/or any of the dedicated or common cladding regions. When relative refractive index varies with radial position r or R in a particular region of the fiber (e.g. core region and/or any of the dedicated or common cladding regions described herein), it is expressed in terms of its actual or approximate functional dependence, or in terms of its value at a particular radial position r or R within the region, or in terms of an average value applicable to the region as a whole. Unless otherwise specified, if the relative refractive index of a region (e.g. core region and/or any of the dedicated or common cladding regions) is expressed as a single value or as a parameter (e.g. D or D %) applicable to the region as a whole, it is understood that the relative refractive index in the region is constant, or approximately constant, and corresponds to the single value, or that the single value or parameter represents an average value of a non-constant relative refractive index dependence with radial position r or R in the region. For example, if i is a region of the glass fiber, the parameter Dᵢ refers to the average value of relative refractive index in the region, unless otherwise specified. Whether by design or a consequence of normal manufacturing variability, the dependence of relative refractive index on radial position may be sloped, curved, or otherwise non-constant.

“Relative refractive index,” as used herein, is defined as:

$$Δ ( r ) \% = 100 \frac{( {n}^{2} ( r ) - {n}_{r e f}^{2} )}{2 {n}^{2} ( r )}$$

where n(r) is the refractive index at radial position r in the glass fiber, unless otherwise specified, and n_{ref} is the refractive index of pure silica glass, unless otherwise specified. For purposes of the present disclosure, n_{ref}=1.444, which is the refractive index of pure silica at 1550 nm. Accordingly, as used herein, the relative refractive index percent is relative to pure silica glass. As used herein, the relative refractive index is represented by Δ (or “delta”) or Δ% (or “delta %) and its values are given in units of “%”, unless otherwise specified. Relative refractive index may also be expressed as Δ(r) or Δ(r) %. An analogous definition of relative refractive index can be expressed in terms of radial coordinate R.

The average relative refractive index (Δₐᵥₑ) of a region of the fiber is determined from the following:

$${Δ}_{a v e} = {\int }_{{r}_{i n n e r}}^{{r}_{o u t e r}} \frac{D ( r ) d r}{( {r}_{outer} - {r}_{i n n e r} )}$$

where rᵢₙₙₑᵣ is the inner radius of the region, rₒᵤₜₑᵣ is the outer radius of the region, and D(r) is the relative refractive index of the region. An analogous definition of average refractive index can be expressed in terms of radial coordinate R.

The “mode field diameter” or “MFD” of a core element of the multicore optical fiber is defined as follows:

$$MFD = 2 w \\ {w}^{2} = 2 \frac{{\int }_{0}^{∞} {( f ( r ) )}^{2} rdr}{{\int }_{0}^{∞} {( \frac{df ( r )}{dr} )}^{2} rdr}$$

where f(r) is the transverse component of the electric field distribution of the guided optical signal in the core element and r is radial position relative to the centerline of the core element. “Mode field diameter” or “MFD” depends on the wavelength of the optical signal and is reported herein for a wavelength of 1310 nm or 1550 nm. Specific indication of the wavelength will be made when referring to mode field diameter. Unless otherwise specified, mode field diameter refers to the LP₀₁ mode at the specified wavelength. Each core element of a multicore optical fibers has a mode field diameter. The mode field diameter may be the same or different for different core elements.

A multicore optical fiber includes two or more core elements. Each core element includes a core region and optionally includes one or more dedicated cladding regions. The multicore optical fiber also includes a cladding region common to the two or more core elements. A cladding region is said to be “dedicated” if it surrounds the core region of only one core element of the two or more core elements; a cladding region is said to be “common” if it surrounds the core regions of at least two core elements of the two or more core elements. The dedicated and common cladding regions may include multiple regions that differ in relative refractive index. The core regions and cladding regions are typically glass.

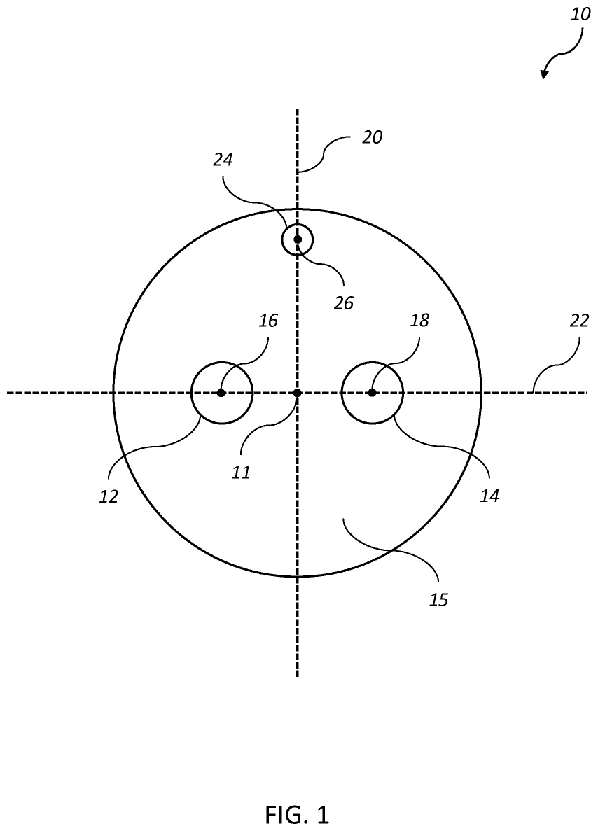

As mentioned above, identification of the core elements can be important for matching core elements in various span lengths to optimize performance. FIGS. 1, 2, and 3 illustrates some existing main pathways for identifying core elements in multicore optical fibers.

Referring to FIG. 1, a cross-sectional view of a multicore optical fiber 10 is shown. The multicore optical fiber 10 having a centerline 11 may include two core elements 12, 14 disposed in a common cladding 15. The core elements 12, 14 may be identical or have the same core element design. The core elements 12, 14 may be arranged in a symmetrical manner in the common cladding 15. Specifically, the core elements 12, 14 may be disposed symmetrically on either side of a first reference plane 20 passing through the centerline 11 of the multicore optical fiber 10. In some embodiments, the respective centerlines 16, 18 of the core elements 12, 14 may be aligned with the centerline 11 of the multicore optical fiber 10 along a second reference plane 22. The second reference plane 22 may be perpendicular to the first reference plane 20.

The multicore optical fiber 10 may further include a marker element 24. The marker element 24 may be used as an alignment reference and is not typically used as a channel for transmitting optical signals. With continued reference to FIG. 1, the marker element 24 includes a centerline 26 that is disposed on the first reference plane 20, and the first reference plane 20 is a plane of symmetry for the marker element 24. Accordingly, the marker element 24 may also be referred to a symmetrical marker element 24.

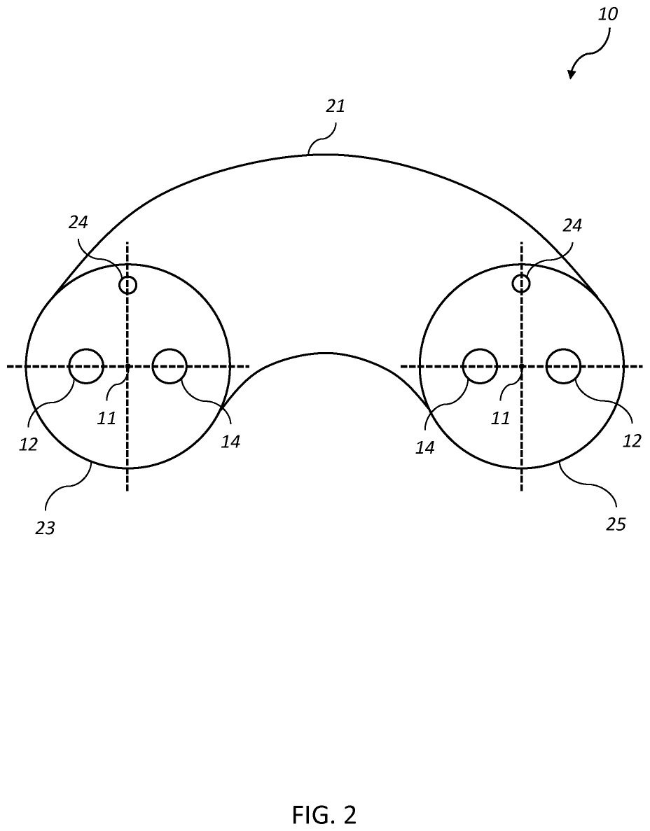

Referring to FIG. 2, a length 21 of the multicore optical fiber 10 having a first end 23 and a second end 25 is schematically illustrated. The first end 23 defines a first cross section of the multicore optical fiber 10, and the second end 25 defines a second cross section of the multicore optical fiber 10. As shown, when viewed along the centerline 11 of the multicore optical fiber 10 into the length 21 of the multicore optical fiber 10, the first cross section of the first end 23 and the second cross section of the second end 25 are identical.

When the marker element 24 is used as an alignment reference during splicing, the first end 23 of a first length of the multicore optical fiber 10 may be spliced to either the first end 23 or the second end 25 of a second length of the multicore optical fiber 10 while maintaining the alignment between the core elements 12, 14 and the marker elements 44 of the first and second lengths of the multicore optical fiber 10. In the case where a connecting device, such as a fan-in fan-out (FIFO) device, may be used for connecting the ends 23, 25 of the multicore optical fiber 10 to another fiber or component, a single FIFO design can be used at either end 23, 25 for connecting the multicore optical fiber 10 to another fiber or component. However, the marker element 24 may not enable determination of the correspondence of the core elements 12, 14 at opposite ends of the multicore optical fiber 10. Thus, the core element 12 of one multicore optical fiber 10 may be aligned and spliced to the core element 12 or the core element 14 of another multicore optical fiber 10. In other words, once the multicore optical fiber 10 is integrated into an optical communication system, the identification or traceability of the core element 12 from the core element 14 may be lost.

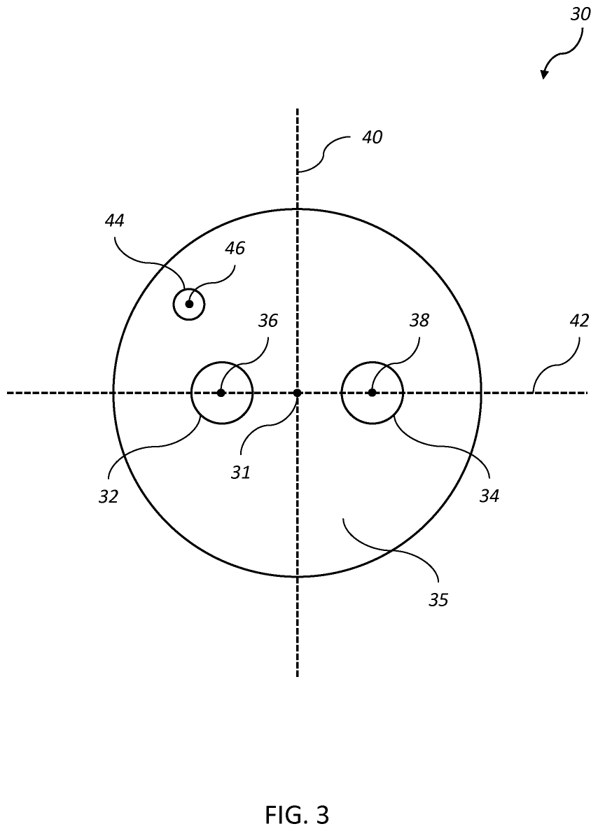

In some instances, it may be desirable to distinguish one core element from another or trace each of the core elements in an optical fiber system. Referring to FIG. 3, a cross-sectional view of a multicore optical fiber 30 is shown. The multicore optical fiber 30 having a centerline 31 may include two core elements 32, 34 disposed in a common cladding 35. In some instances, the core elements 32, 34 may be identical or have the same core element design. The core elements 32, 34 may be arranged in a symmetrical manner in the common cladding 35. Specifically, the core elements 32, 34 may be disposed symmetrically on either side of a first reference plane 40 passing through the centerline 31 of the multicore optical fiber 30. In some embodiments, the centerlines 36, 38 of the core elements 32, 34 may also be aligned with the centerline 31 of the multicore optical fiber 30 along a second reference plane 42. The second reference plane 42 may be perpendicular to the first reference plane 40. The multicore optical fiber 30 may further include a marker element 44. Different from the marker element 24, a centerline 46 of the marker element 44 is not disposed on but offset from the first reference plane 40. Accordingly, the marker element 44 may also be referred to an asymmetrical marker element 44. The asymmetrical marker element 44 may be utilized to distinguish core element 32 from the core element 34 at the ends of the multicore optical fiber 30. However, to maintain the traceability of the core elements 32, 34, the connection between the multicore optical fiber 30 to another multicore optical fiber 30 of the same design need to be between ends having opposite handedness as explained below.

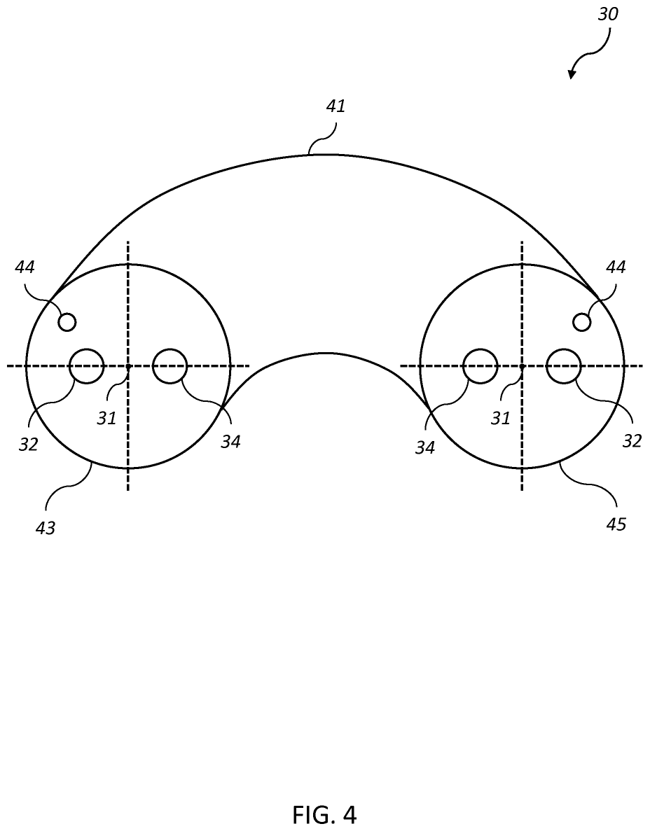

Referring to FIG. 4, a length 41 of the multicore optical fiber 30 having a first end 43 and a second end 45 is schematically illustrated. The first end 43 defines a first cross section of the multicore optical fiber 30, and the second end 45 defines a second cross section of the multicore optical fiber 30. As shown, when viewed along the centerline 31 of the multicore optical fiber 30 into the length 41 of the multicore optical fiber 30, the first cross section of the first end 43 and the second cross section of the second end 45 are not identical but a mirror image of each other. For description purposes, the first end 43 is also referred to as the left-hand end 43, and the second end 45 is also referred to as the right-hand end 45.

In order to align the core elements 32, 34 and the marker element 44 of a first length of the multicore optical fiber 30 to the core elements 32, 34 and the marker element 44 of a second length of the multicore optical fiber 30, the first (or left-hand) end 43 of the first length of the multicore optical fiber 30 needs to be spliced to the second (or right-hand) end 45 of the second length of the multicore optical fiber 30. Similarly, the second (or right-hand) end 45 of the first length of the multicore optical fiber 30 needs to be spliced to the first (or left-hand) end 43 of a third length of the multicore optical fiber 30. When a connecting device, such as a FIFO device, may be employed, two different FIFO designs need to be implemented at the first (or left-hand) end 43 and the second (or right-hand) end 45.

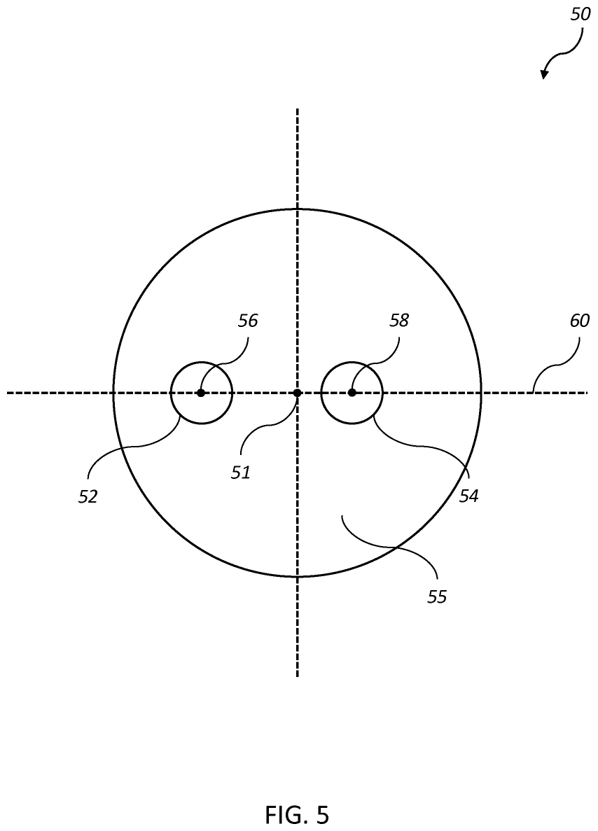

FIG. 5 schematically shows a cross-sectional view of a multicore optical fiber 50, illustrating another pathway for identifying core elements 52, 54 of the multicore optical fiber 50. As shown, the core elements 52, 54 are disposed in the common cladding 55 of the multicore optical fiber 50 in an offset manner. Specifically, the respective centerlines 56, 58 of the core elements 52, 54 are aligned with the centerline 51 of the multicore optical fiber 50 along a reference plane 60 passing through the centerline 51 of the multicore optical fiber 50, but are shifted along the reference plane 60 such that the core element 52 is disposed further away from the centerline 51 of the multicore optical fiber 50 than the core element 54. The core elements 52, 54 may be identical other than their respective dispositions in the common cladding 55. The offset arrangement of the core elements 52, 54 allows for identification of individual core elements 52, 54. However, the offset arrangement of the core elements 52, 54 does not identify fiber direction (or the left- or right-handedness of the fiber ends) in that the opposite ends of the multicore optical fiber 50 are indistinguishable. Further, the potential performance of the core elements 52, 54 may be asymmetrical by placing one closer to the outer periphery of the common cladding 55.

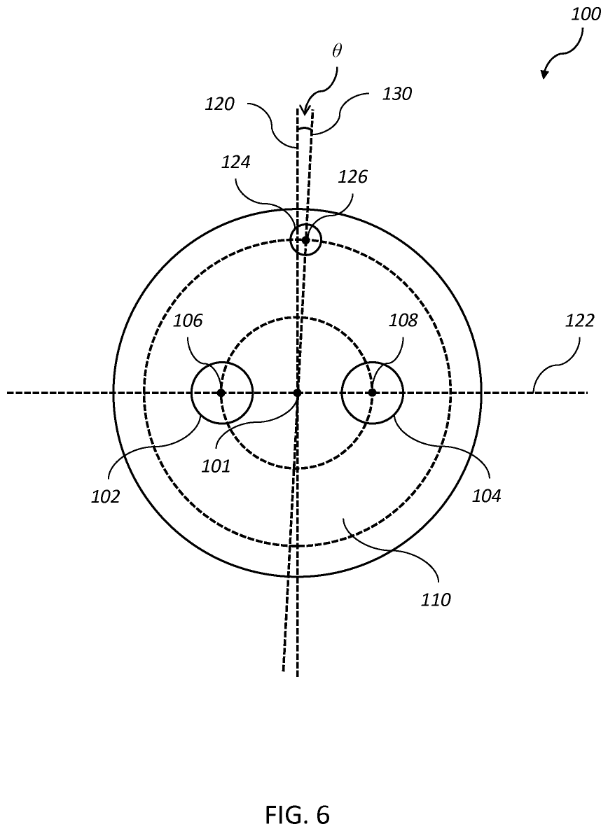

FIG. 6 shows a cross-sectional view of an exemplary multicore optical fiber 100 that overcomes the limitations of each of the symmetric marker element 24, the asymmetric marker element 44, and the offset core arrangement discussed above. Referring to FIG. 6, in some embodiments, the multicore optical fiber 100 having a centerline 101 may include a first core element 102 and a second core element 104 disposed in a common cladding 110. In some embodiments, the first core element 102 and the second core element 104 may be identical or have the same core element design. In some embodiments, the first core element 102 and the second core element 104 may not be identical but nonetheless may not be easily distinguished from each other without aid. In some embodiments, each of the first core element 102, the second core element 104, and the common cladding 110 may include a circular cross section.

The first core element 102 and the second core element 104 may be arranged in a symmetrical manner in the common cladding 110. Specifically, the first core element 102 and the second core element 104 may be disposed symmetrically on either side of a first reference plane 120 passing through the centerline 101 of the multicore optical fiber 100. Thus, the first core element 102 and the second core element 104 may be disposed at an equal radial distance from the centerline 101 of the multicore optical fiber 100. In some embodiments, the centerline 106 of the first core element 102 and the centerline 108 of the second core element 104 may be disposed on a second reference plane 122 perpendicular to the first reference plane 120. In some embodiments, the second reference plane 122 may also pass the centerline 101 of the multicore optical fiber 100. Thus, the centerline 101 of the multicore optical fiber 100, the centerline 106 of the first core element 102, and/or the centerline 108 of the second core element 104 may be aligned along the second reference plane 122.

With continued reference to FIG. 6, the multicore optical fiber 100 may further include a marker element 124. The marker element 124 may be used as an alignment reference and is not typically used as a channel for transmitting optical signals. The marker element 124 may include a refractive index different from the refractive index of the common cladding 110. The marker element 124 may be the only marker element disposed in the common cladding 110 of the multicore optical fiber 100. The marker element 124 may be disposed in the common cladding 110 such that the first reference plane 120 may pass through the marker element 124. However, the marker element 224 may be disposed asymmetrically about the first reference plane 120.

In some embodiments, the marker element 124 may include a symmetrical cross section. In some embodiments, the cross section of the marker element 124 may be symmetrical about a third reference plane 130 (also referred to as a plane of symmetry of the marker element 124) passing through a centerline 126 of the marker element 124. The centerline 126 of the marker element 124 may be offset and away from the first reference plane 120. In other words, the first reference plane 120 may not pass through the centerline 126 of the marker element 124. In some embodiments, the third reference plane 130 may further pass through the centerline 101 of the multicore optical fiber 100. Thus, the third reference plane 130 and the first reference plane 120 may intersect each other at the centerline 101 of the multicore optical fiber 100 and may be rotationally offset from each other about the centerline 101 of the multicore optical fiber 100. In some embodiments, the marker element 124 may include a circular cross section.

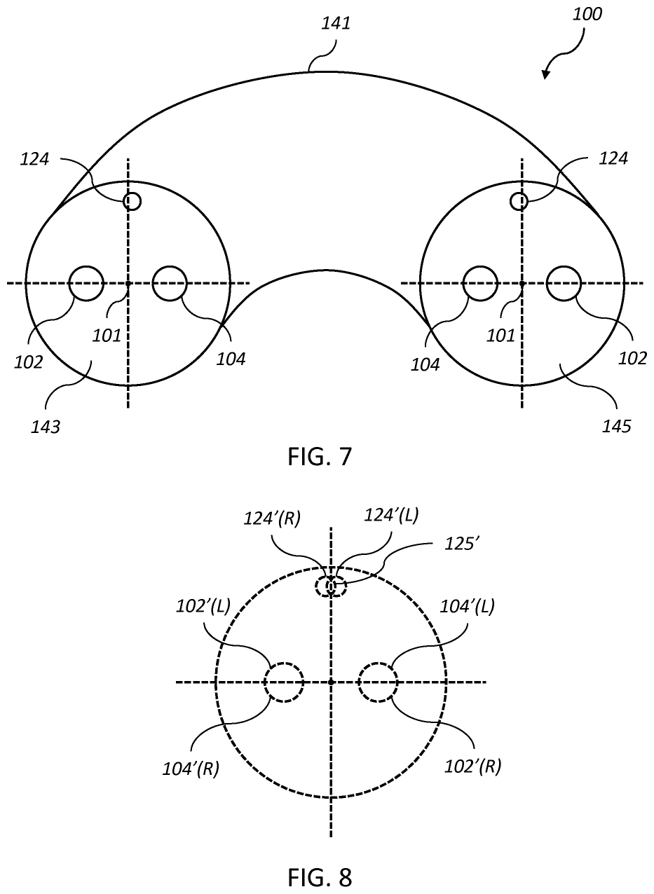

As the marker element 124 may be asymmetrically disposed about or offset from the first reference plane 120 about which the first core element 102 and the second core element 104 are symmetrically arranged, the marker element 124 can be utilized to identify the first core element 102 from the second core element 104 at either end of the multicore optical fiber 100. Specifically, referring to FIG. 7, a length 141 of the multicore optical fiber 100 having a first end 143 and a second end 145 is schematically shown. The first end 143 defines a first cross section of the multicore optical fiber 100, and the second end 145 defines a second cross section of the multicore optical fiber 100. As shown, when viewed along the centerline 101 of the multicore optical fiber 100 into the length 141 of the multicore optical fiber 100, the first cross section of the first end 143 and the second cross section of the second end 145 are not identical but a mirror image of each other due to the asymmetrical disposition of the marker element 124 about the first reference plane 120. For description purposes, the first end 143 is also referred to as the left-hand end 143, the second end 145 is also referred to as the right-hand end 145, the first cross section of the first end 143 is also referred to as the left-hand cross section of the first (or left-hand) end 143, and the second cross section of the second end 145 is also referred to as the right-hand cross section of the second (or right-hand) end 145.

Referring to FIG. 8, when the second (or right-hand) cross section of the second (or right-hand) end 145 is superimposed on the first (or left-hand) cross section of the first (or left-hand) end 143, the cross-sectional shape 102′(L) of the first core element 102 from the first (or left-hand) cross section can be aligned with the cross-sectional shape 104′(R) of the second core element 104 from the second (or right-hand) cross section, and the cross-sectional shape 102′(R) of the first core element 102 from the second (or right-hand) cross section can be aligned with the cross-sectional shape 104′(L) of the second core element 104 from the first (or left-hand) cross section, but the cross-sectional shape 124′(L) of the marker element 124 from the first (or left-hand) cross section only partially overlaps with and is offset from the cross-sectional shape 124′(R) of the marker element 124 from the second (or right-hand) cross section. Such offset or asymmetrical disposition of the marker element 124 allows the first core element 102 and the second core element 104 to be identified or traced individually at either the first (or left-hand) end 143 or the second (or right-hand) end 145 of the multicore optical fiber 100.

Although the asymmetrical marker element 44 discussed above with reference to FIGS. 3 and 4 also maintains identification or traceability of the core elements 32, 34, in order to ensure alignment of the core elements 32, 34 and the marker element 44 from a first length of the multicore optical fiber 30 to a second length of the multicore optical fiber 30, the first (or left-hand) end 43 of the first length of the multicore optical fiber 30 needs to be spliced to the second (or right-hand) end 45 of the second length of the multicore optical fiber 30. Further, different FIFO designs are needed for the first (or left-hand) end 43 and the second (or right-hand) end 45 of the multicore optical fiber 30.

In contrast, the multicore optical fiber 100 described herein may allow the first (or left-hand) end 143 of a first length of the multiple multicore optical fibers 100 to be spliced to either the first (or left-hand) end 143 or the second (or right-hand) end 145 of a second length of the multicore optical fiber 100 to establish connectivity for the core elements 102, 104 while still achieving sufficient cross-sectional overlap between the marker element 124 of the first length of the multicore optical fiber 100 and the marker element 124 of the second length of the multicore optical fiber 100. The multicore optical fiber 100 described herein thus allows splicing flexibility without requiring respooling or tracking the direction of the multicore optical fiber 100 on a spool.

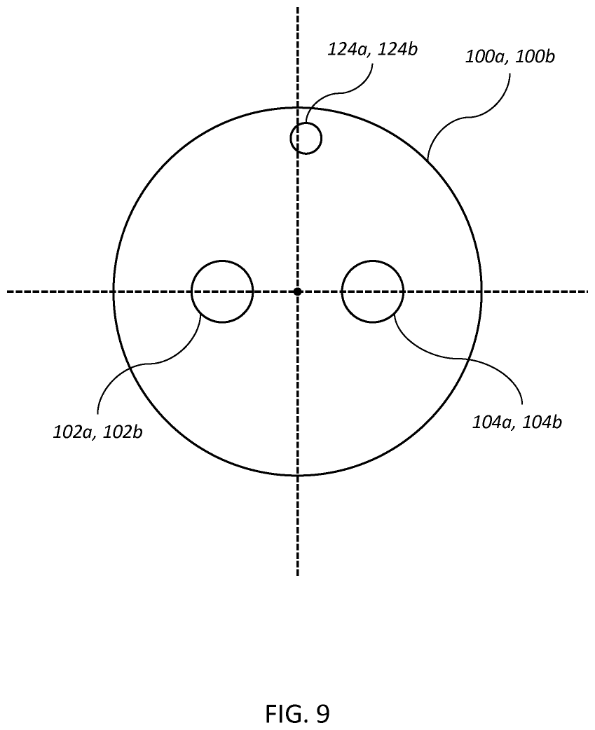

FIG. 9 schematically illustrates when the first (or left-hand) end 143a of a first length of the multicore optical fiber 100a is spliced to the second (or right-hand) end 145b of a second length of the multicore optical fiber 100b, the relative positions of the first core element 102a, the second core element 104a, and the marker element 124a of the first length of the multicore optical fiber 100a and the first core element 102b, the second core element 104b, and the marker element 124b of the second length of the multicore optical fiber 100b at the location of splice. As shown, the first core element 102a of the first length of the multicore optical fiber 100a and the first core element 102b of the second length of the multicore optical fiber 100b are aligned, the second core element 104a of the first length of the multicore optical fiber 100a and the second core element 104b of the second length of the multicore optical fiber 100b are aligned, and the marker element 124a of the first length of the multicore optical fiber 100a and the marker element 124b of the second length of the multicore optical fiber 100b are aligned. Similarly, if the second (or right-hand) end 145a of the first length of the multicore optical fiber 100a is spliced to the first (or left-hand) end 143b of the second length of the multicore optical fiber 100b, the respective first core elements 102a, 102b, second core elements 104a, 104b, and marker elements 124a, 124b would also align.

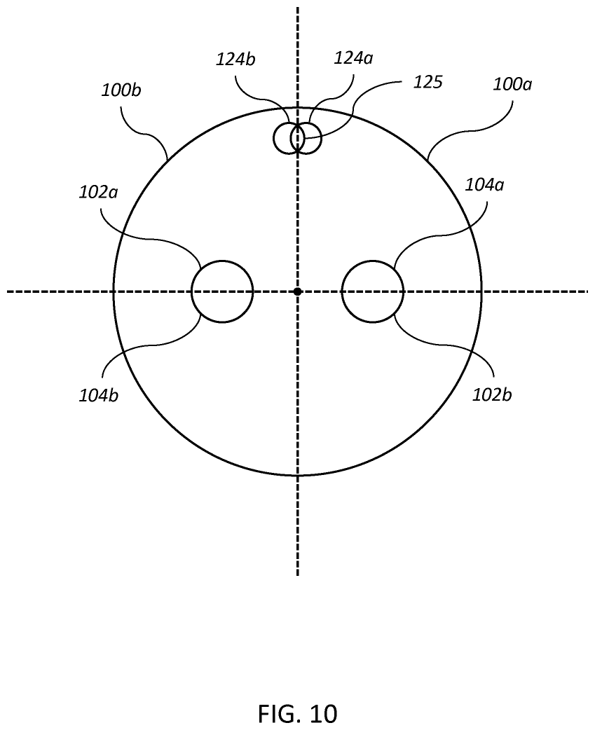

FIG. 10 schematically illustrates when the first (or left-hand) end 143a of the first length of the multicore optical fiber 100a is spliced to the first (or left-hand) end 143b of the second length of the multicore optical fiber 100b, the relative positions of the first core element 102a, the second core element 104a, and the marker element 124a of the first length of the multicore optical fiber 100a and the first core element 102b, the second core element 104b, and the marker element 124b of the second length of the multicore optical fiber 100b at the location of splice. As shown, the first core element 102a of the first length of the multicore optical fiber 100a and the second core element 104b of the second length of the multicore optical fiber 100b are aligned, the second core element 104a of the first length of the multicore optical fiber 100a and the first core element 102b of the second length of the multicore optical fiber 100b are aligned, and the marker element 124a of the first length of the multicore optical fiber 100a and the marker element 124b of the second length of the multicore optical fiber 100b overlap with each other but are not aligned.

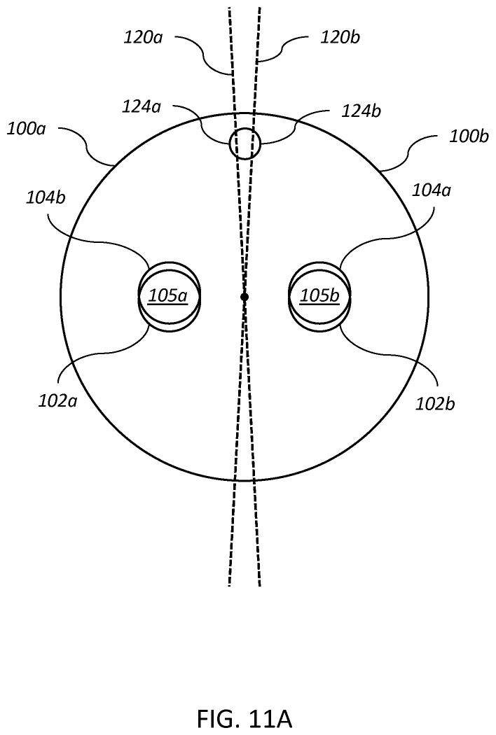

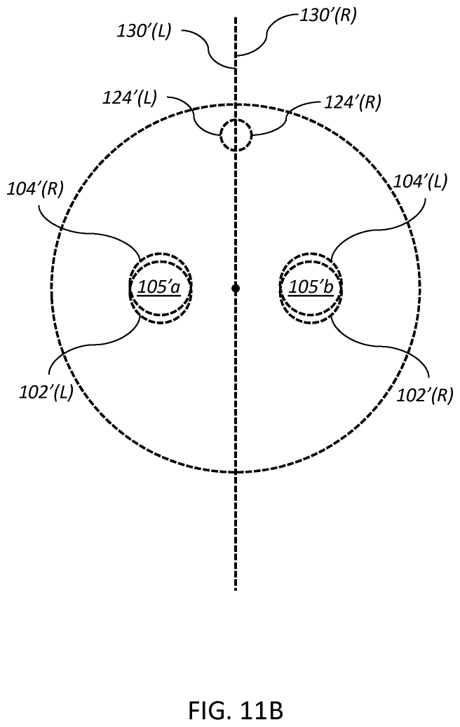

Although not completely aligned, the partial overlap between the marker elements 124a, 124b may be sufficient to allow splicing process, equipment, and/or software for splicing multicore optical fibers with a symmetrical marker element, such as the multicore optical fiber 10 described above, to be used for splicing the multicore optical fibers 100 described herein. Specifically, during splicing, the marker element 124a of the first length of the multicore optical fiber 100a and the marker element 124b of the second length of the multicore optical fiber 100b may be aligned to bring the core elements 102, 104 to close proximity as an initial step, followed by fine adjustment to align the core elements 102, 104. If the ends of the same handedness (i.e., the first (or left-hand) end 143a of the first length of the multicore optical fiber 100a and the first (or left-hand) end 143b of the second length of the multicore optical fiber 100b, or the second (or right-hand) end 145a of the first length of the multicore optical fiber 100a and the second (or right-hand) end 145b of the second length of the multicore optical fiber 100b) are brought together for splicing, when the marker element 124a from the first length of the multicore optical fiber 100a and the marker element 124b from the second length of the multicore optical fiber 100b are aligned, the core elements 102a, 102b, 104a, 104b would also be brought to close proximity with a sufficient area of overlap 105a, 105b, as illustrated in FIG. 11A, for subsequent fine adjustment to align the core elements 102a, 102b, 104a, 104b because the respective marker element 124a, 124b is only slightly offset from the respective first reference plane 120a, 120b about which the respective core elements 102a, 102b, 104a, 104b are symmetrically arranged.

In some embodiments, the area of overlap 105a between the core element 102a and the core element 104b and/or the area of overlap 105b between the core element 102b and the core element 104a may be greater than or equal to (i.e., ≥) 10%, ≥15%, ≥20%, ≥25%, ≥30%, ≥35%, ≥40%, ≥45%, ≥50%, ≥55%, ≥60%, ≥65%, ≥70%, ≥75%, ≥80%, ≥85%, or ≥90% of the cross sectional area of any of the core elements 102a, 102b, 104a, 104b. In some embodiments, the area of overlap 105a between the core element 102a and the core element 104b and/or the area of overlap 105b between the core element 102b and the core element 104a may be less than or equal to (i.e., ≤) 95%, ≤90%, ≤85%, ≤80%, ≤75%, ≤70%, ≤65%, ≤60%, ≤55%, ≤50%, ≤45%, ≤40%, ≤35%, ≤30%, ≤25%, ≤20%, or ≤15% of the cross sectional area of any of the core elements 102a, 102b, 104a, 104b. In some embodiments, the area of overlap 105a between the core element 102a and the core element 104b and/or the area of overlap 105b between the core element 102b and the core element 104a may be greater than or equal to (i.e., ≥) 10% and less than or equal to (i.e., ≤) 95%—including all sub-ranges or values therebetween—of the cross sectional area of any of the core elements 102a, 102b, 104a, 104b. For example, in some embodiments, the area of overlap 105a between the core element 102a and the core element 104b and/or the area of overlap 105b between the core element 102b and the core element 104a may be ≥10% and ≤95%, ≥10% and ≤60%, ≥10% and ≤35%, ≥35% and ≤95%, ≥35% and ≤60%, or ≥60% and ≤95% of the cross sectional area of any of the core elements 102a, 102b, 104a, 104b.

FIG. 11B, similar to FIG. 8, shows another image formed by superimposing the second (or right-hand) cross section of the second (or right-hand) end 145 on the first (or left-hand) cross section of the first (or left-hand) end 143 of the multicore optical fiber 100. FIG. 11B differs from FIG. 8 in that the cross-sectional shape 124′(L) and the cross-sectional shape 124′(R) of the marker element 124, as well as the respective planes of symmetry 130′(L), 130′(R), align with each other, whereas the cross-sectional shape 102′(L) overlaps with but is offset from the cross-sectional shape 104′(R), and the cross-sectional shape 102′(R) overlaps with but is also offset from the cross-sectional shape 104′(L). As would be appreciated, the area of overlap 105′a, 105′b would correspond to the area of overlap 105a, 105b shown in FIG. 11A.

In some embodiments, the area of overlap 105′a, 105′b may be greater than or equal to (i.e., ≥) 10%, ≥15%, ≥20%, ≥25%, ≥30%, ≥35%, ≥40%, ≥45%, ≥50%, ≥55%, ≥60%, ≥65%, ≥70%, ≥75%, ≥80%, ≥85%, or ≥90% of the cross sectional area of any of the core elements 102, 104 or any of the cross-sectional shapes 102′(L), 104′(L), 102′(R), 104′(R). In some embodiments, the area of overlap 105′a, 105′b may be less than or equal to (i.e., ≤) 95%, ≤90%, ≤85%, ≤80%, ≤75%, ≤70%, ≤65%, ≤60%, ≤55%, ≤50%, ≤45%, ≤40%, ≤35%, ≤30%, ≤25%, ≤20%, or ≤15% of the cross sectional area of any of the core elements 102, 104 or any of the cross-sectional shapes 102′(L), 104′(L), 102′(R), 104′(R). In some embodiments, the area of overlap 105′a, 105′b may be greater than or equal to (i.e., ≥) 10% and less than or equal to (i.e., ≤) 95%—including all sub-ranges or values therebetween—of the cross sectional area of any of the core elements 102, 104 or any of the cross-sectional shapes 102′(L), 104′(L), 102′(R), 104′(R). For example, in some embodiments, the area of overlap 105′a, 105′b may be ≥10% and ≤95%, ≥10% and ≤60%, ≥10% and ≤35%, ≥35% and ≤95%, ≥35% and ≤60%, or ≥60% and ≤95% of the cross sectional area of any of the core elements 102, 104 or any of the cross-sectional shapes 102′(L), 104′(L), 102′(R), 104′(R).

When the ends of the same handedness are spliced together, such as when the first (or left-hand) end 143a of the first length of the multicore optical fiber 100a and the first (or left-hand) end 143b of the second length of the multicore optical fiber 100b are spliced together as shown in FIG. 10, the area of overlap 125 between the marker element 124a and the marker element 124b may be greater than or equal to (≥) 10%, ≥15%, ≥20%, ≥25%, ≥30%, ≥35%, ≥40%, ≥45%, ≥50%, ≥55%, ≥60%, ≥65%, ≥70%, ≥75%, ≥80%, ≥85%, or ≥90% of an entire cross-sectional area of the marker element 124a and/or the marker element 124b in some embodiments. In some embodiments, the area of overlap 125 between the marker element 124a and the marker element 124b may be less than or equal to (≤) 95%, ≤90%, ≤85%, ≤80%, ≤75%, ≤70%, ≤65%, ≤60%, ≤55%, ≤50%, ≤45%, ≤40%, ≤35%, ≤30%, ≤25%, ≤20%, or ≤15% of the entire cross-sectional area of the marker element 124a and/or the marker element 124b. In some embodiments, the area of overlap 125 between the marker element 124a and the marker element 124b may be greater than or equal to (i.e., ≥) 10% and less than or equal to (i.e., ≤) 95% of the entire cross-sectional area of the marker element 124a and/or the marker element 124b—including all sub-ranges or values therebetween. For example, in some embodiments, the area of overlap 125 between the marker element 124a and the marker element 124b may be ≥10% and ≤95%, ≥10% and ≤60%, ≥10% and ≤35%, ≥35% and ≤95%, ≥35% and ≤60%, or ≥60% and ≤95% of the entire cross-sectional area of the marker element 124a and/or the marker element 124b. It should be noted that the area of overlap 125 described herein represents more than mere manufacturing variations so as to enable identification of the core elements 102, 104 from each other.

As would be appreciated, the area of overlap 125 shown in FIG. 10 corresponds to the area of overlap 125′ between the cross-sectional shape 124′(L) and the cross-sectional shape 124′(R) shown in FIG. 8. Accordingly, the area of overlap 125′ between the cross-sectional shape 124′(L) and the cross-sectional shape 124′(R) may be greater than or equal to (≥) 10%, ≥15%, ≥20%, ≥25%, ≥30%, ≥35%, ≥40%, ≥45%, ≥50%, ≥55%, ≥60%, ≥65%, ≥70%, ≥75%, ≥80%, ≥85%, or ≥90% of the entire cross-sectional area of the marker element 124a and/or the marker element 124b in some embodiments. In some embodiments, the area of overlap 125′ between the cross-sectional shape 124′(L) and the cross-sectional shape 124′(R) may be less than or equal to (≤) 95%, ≤90%, ≤85%, ≤80%, ≤75%, ≤70%, ≤65%, ≤60%, ≤55%, ≤50%, ≤45%, ≤40%, ≤35%, ≤30%, ≤25%, ≤20%, or ≤15% of the entire cross-sectional area of the marker element 124a and/or the marker element 124b. In some embodiments, the area of overlap 125′ between the cross-sectional shape 124′(L) and the cross-sectional shape 124′(R) may be greater than or equal to (i.e., ≥) 10% and less than or equal to (i.e., ≤) 95% of the entire cross-sectional area of the marker element 124a and/or the marker element 124b—including all sub-ranges or values therebetween. For example, in some embodiments, the area of overlap 125′ between the cross-sectional shape 124′(L) and the cross-sectional shape 124′(R) may be ≥10% and ≤95%, ≥10% and ≤60%, ≥10% and ≤35%, ≥35% and ≤95%, ≥35% and ≤60%, or ≥60% and ≤95% of the entire cross-sectional area of the marker element 124a and/or the marker element 124b. It should be noted that the area of overlap 125′ described herein represents more than mere manufacturing variations so as to enable identification of the core elements 102, 104 from each other.

Referring back to FIG. 6, in some embodiments, the angle θ between the first reference plane 120 about which the core elements 102, 104 are symmetrically disposed and the third reference plane 130 (or the plane of symmetry 130 of the marker element 124) may be greater than or equal to (≥) 0.5°, ≥1°, ≥1.5°, ≥2°, ≥2.5°, ≥3°, ≥3.5°, ≥4°, ≥4.5°, ≥5°, ≥5.5°, ≥6°, ≥6.5°, ≥7°, ≥7.5°, ≥8°, ≥8.5°, ≥9°, ≥9.5° or greater. In some embodiments, the angle θ between the first reference plane 120 and the third reference plane 130 may be less than or equal to (≤) 10°, ≤9.5°, ≤9°, ≤8.5°, ≤8°, ≤7.5°, ≤7°, ≤6.5°, ≤6°, ≤5.5°, ≤5°, ≤4.5°, ≤4°, ≤3.5°, ≤3°, ≤2.5°, ≤2°, ≤1.5°, ≤1°, or less. In some embodiments, the angle θ between the first reference plane 120 and the third reference plane 130 may be greater than or equal to (i.e., ≥) 0.5° and less than or equal to (i.e., ≤) 10°—including all sub-ranges or values therebetween. For example, in some embodiments, the angle θ between the first reference plane 120 and the third reference plane 130 may be ≥0.5° and ≤10°, ≥0.5° and ≤8°, ≥0.5° and ≤6°, ≥0.5° and ≤4°, ≥0.5° and ≤2°, ≥2° and ≤10°, ≥2° and ≤8°, ≥2° and ≤6°, ≥2° and ≤4°, ≥4° and ≤10°, ≥4° and ≤8°, ≥4° and ≤6°, ≥6° and ≤10°, ≥6° and ≤8°, or ≥8° and ≤10°. The angle θ between the first reference plane 120 and the third reference plane 130 may also be referred to as the rotational offset between the first reference plane 120 and the third reference plane 130 about the centerline 101 of the multicore optical fiber 100. It should be noted that the angle θ between the first reference plane 120 and the third reference plane 130 represents more than mere manufacturing variations so as to enable identification of the core elements 102, 104 from each other.

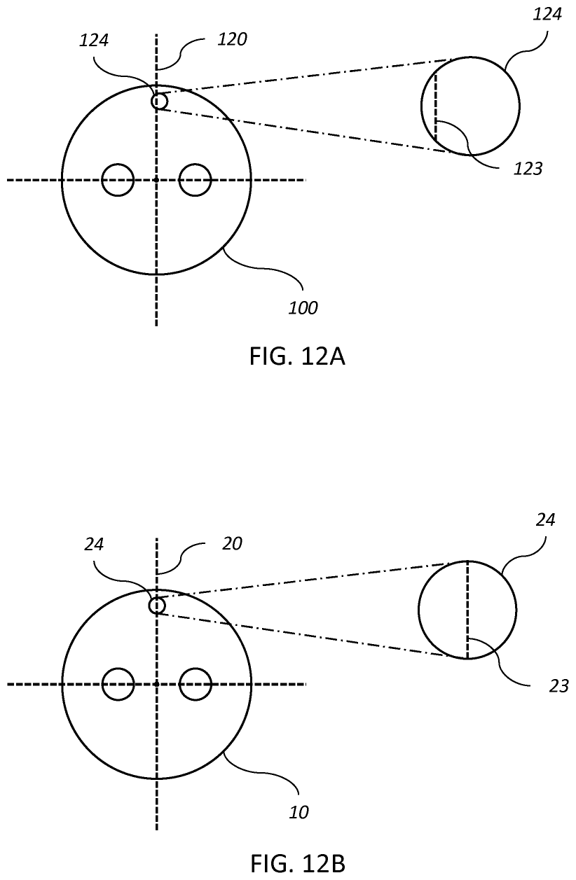

Referring to FIG. 12A, the cross section of the multicore optical fiber 100 of FIG. 6 is reproduced along with an inset showing the marker element 124. As shown, a length 123 of the first reference plane 120 passing through the marker element 124 is less than the diameter of the marker element 124. In contrast, with reference to FIG. 12B which shows the cross section of the multicore optical fiber 10 of FIG. 1 along with an inset showing the marker element 24, a length 23 of the first reference plane 20 passing through the marker element 24 of the multicore optical fiber 10 corresponds to the diameter of the marker element 24 due to the symmetrical disposition of the marker element 24 about the first reference plane 20.

In some embodiments, the length 123 of the first reference plane 120 passing through the marker element 124 may be greater than or equal to (≥) 20%, ≥25%, ≥30%, ≥35%, ≥40%, ≥45%, ≥50%, ≥55%, ≥60%, ≥65%, ≥70%, ≥75%, ≥80%, ≥85%, ≥90%, or ≥95% of the diameter of the marker element 124. In some embodiments, the length 123 of the first reference plane 120 passing through the marker element 124 may be less than or equal to (≤) 99.8%, ≤95%, ≤90%, ≤85%, ≤80%, ≤75%, ≤70%, ≤65%, ≤60%, ≤55%, ≤50%, ≤45%, ≤40%, ≤35%, ≤30%, or ≤25% of the diameter of the marker element 124. In some embodiments, the length 123 of the first reference plane 120 passing through the marker element 124 may be greater than or equal to (i.e., ≥) 20% and less than or equal to (i.e., ≤) 99.8% of the diameter of the marker element 124—including all sub-ranges or values therebetween. For example, in some embodiments, the length 123 of the first reference plane 120 passing through the marker element 124 may be ≥20% and ≤99.8%, ≥20% and ≤80%, ≥20% and ≤60%, ≥20% and ≤40%, ≥40% and ≤99.8%, ≥40% and ≤80%, ≥40% and ≤60%, ≥60% and ≤99.8%, ≥60% and ≤80%, or ≥80% and ≤99.8% of the diameter of the marker element 124. It should be noted that the range of the length 123 described herein represents more than mere manufacturing variations so as to enable identification of the core elements 102, 104 from each other.

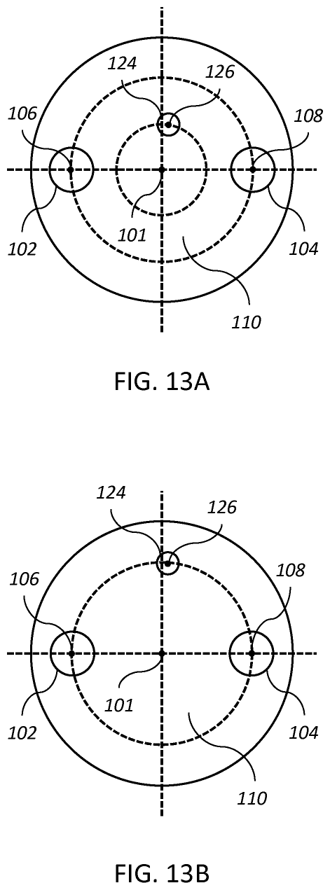

In some embodiments, the centerline 126 of the marker element 124 may be disposed in the common cladding 110 further away from the centerline 101 of the multicore optical fiber 100 than the centerline 106 of the first core element 102 and/or the centerline 108 of the second core element 104, such as shown in FIG. 6. In some embodiments, the centerline 126 of the marker element 124 may be disposed in the common cladding 110 closer to the centerline 101 of the multicore optical fiber 100 than the centerline 106 of the first core element 102 and/or the centerline 108 of the second core element 104, such as shown in FIG. 13A. In some embodiments, the centerline 126 of the marker element 124, the centerline 106 of the first core element 102, and/or the centerline 108 of the second core element 104 may be disposed at the same radial distance from the centerline 101 of the multicore optical fiber 100, such as shown in FIG. 13B.

Although the multicore optical fiber 100 having two core elements 102, 104 is described above, the slight offset disposition of the marker element 124 about the first reference plane 120 may be implemented for identification or tracing of the core elements in multicore optical fibers having any number of core elements.

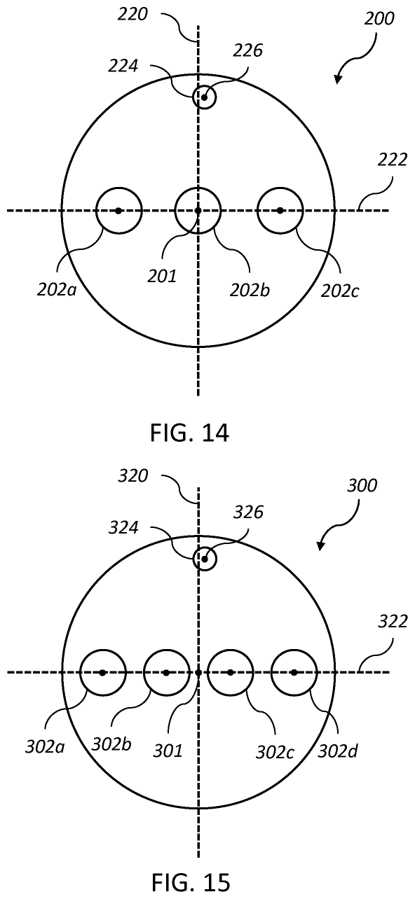

FIGS. 14 and 15 show cross-sectional views of additional exemplary multicore optical fibers 200, 300 according to some embodiments. Each of the multicore optical fibers 200, 300 may include more than two core elements 202, 302, such as three core elements 202a, 202b, 202c shown in FIG. 14 or four core elements 302a, 302b, 302c, 302d shown in FIG. 15. The core elements 202, 302 may be disposed symmetrically about a first reference plane 220, 320 passing through the centerline 201, 301 of the multicore optical fiber 200, 300. Further, in some embodiments, the core elements 202, 302, more specifically, the centerlines thereof, may be disposed in a linear manner (e.g., 1×3, 1×4) on a second reference plane 222, 322 that is perpendicular to the first reference plane 220, 320. In some embodiments, the second reference plane 222, 322 may also pass the centerline 201, 301 of the multicore optical fiber 200, 300. Similar to the marker element 124, the marker element 224, 324 is disposed asymmetrically about the first reference plane 220, 320 such that each of the individual core elements 202, 302 can be identified and traced. Additionally, the marker element 224, 324 is only slightly offset from the first reference plane 220, 320 and the first reference plane 220, 320 passes through the marker element 224, 324 such that ends of the multicore optical fiber 200, 300 having either the same or opposite handedness may be spliced together, saving the hassle of respooling the fiber or tracking the fiber direction.

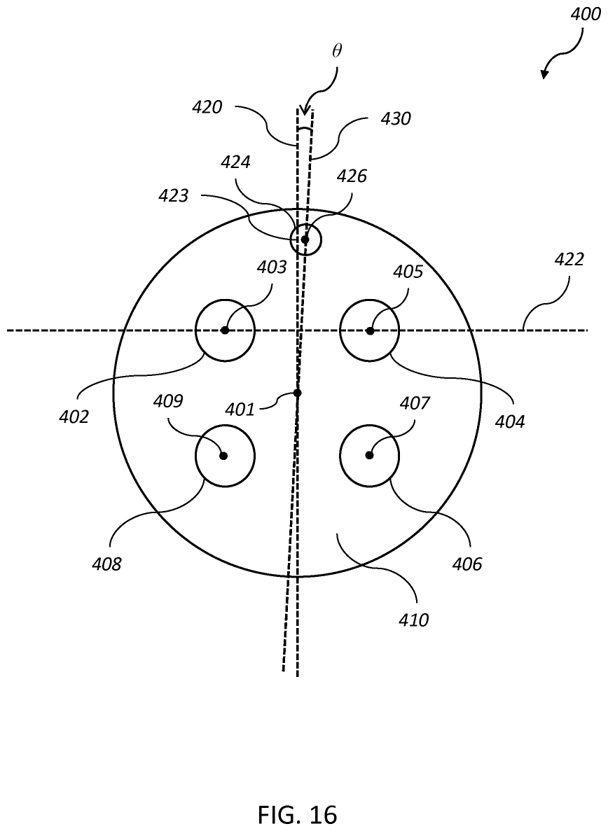

FIG. 16 shows a cross-sectional view of another exemplary multicore optical fiber 400 according to some embodiments. The multicore optical fiber 400 having a centerline 401 may include a first core element 402, a second core element 404, a third core element 406, and a fourth core element 408 disposed in a common cladding 410. In some embodiments, the first core element 402, the second core element 404, the third core element 406, and/or the fourth core element 408 may be identical or have the same core element design. In some embodiments, the first core element 402, the second core element, 404, the third core element 406, and/or the fourth core element 408 may not be identical but nonetheless may not be easily distinguished from one another without aid. In some embodiments, each of the first core element 402, the second core element 404, the third core element 406, the fourth core element 408, and/or the common cladding 410 may include a circular cross section. In some embodiments, the core elements 402, 404, 406, 408 may be disposed at an equal radial distance from the centerline 401 of the multicore optical fiber 400. Specifically, the respective centerlines 403, 405, 407, 409 of the core elements 402, 404, 406, 408 may be disposed at an equal distance from the centerline 401 of the multicore optical fiber 400.

Each of the core elements 402, 404, 406, 408 may be separated from a nearest-neighbor core element by a minimum core separation distance. The term “nearest-neighbor core element” of a core element is used herein to denote another core element having a centerline that is most proximate to that core element. In some embodiments, a core element may include more than one nearest-neighbor core elements.

In some embodiments, the core elements 402, 404, 406, 408 may be disposed symmetrically about a first reference plane 420 passing through the centerline 401 of the multicore optical fiber 400. In some embodiments, each of the centerlines 403, 405, 407, 409 of the core elements 402, 404, 406, 408 may be disposed at a corner of a quadrilateral (e.g., square, rectangle, trapezoid, etc.) with the first reference plane 420 being a plane of symmetry thereof. In some embodiments, the core elements 402, 404, 406, 408 may be disposed in the common cladding 410 in a 2×2 arrangement with the centerlines 403, 405, 407, 409 of the core elements 402, 404, 406, 408 being disposed at the corner of a square that is centered at the centerline 401 of the multicore optical fiber 400.

In some embodiments, the first reference plane 420 may not pass any of the core elements 402, 404, 406, 408. For example, in some embodiments, the first core element 402 and the fourth core element 408 may be disposed on one side of the first reference plane 420, and the second core element 404 and the third core element 406 may be disposed on the other side of the first reference plane 420. The arrangement of the second core element 404 and the third core element 406 may be symmetrical to the arrangement of the first core element 402 and the fourth core element 408 about the first reference plane 420.

In some embodiments, two nearest-neighbor core elements may be disposed symmetrically about the first reference plane 420. For example, in some embodiments, the first core element 402 and the second core element 404 may be nearest-neighbor core elements, with the distance between the centerline 403 of the first core element 402 and the centerline 405 of the second core element 404 being less than or equal to the distance between centerlines of any two of the core elements 402, 404, 406, 408 of the multicore optical fiber 400. The first core element 402 and the second core element 404 may be disposed symmetrically about the first reference plane 420. In some embodiments, the centerline 403 of the first core element 402 and the centerline 405 of the second core element 404 may be disposed on a second reference plane 422 perpendicular to the first reference plane 420. In some embodiments, the second reference plane 422 may not pass the centerline 401 of the multicore optical fiber 400 and may be offset from the centerline 401 of the multicore optical fiber 400.

With continued reference to FIG. 16, the multicore optical fiber 400 may further include a marker element 424. The marker element 424 may be used as an alignment reference and is not typically used as a channel for transmitting optical signals. The marker element 424 may include a refractive index different from the refractive index of the common cladding 410. The marker element 424 may be the only marker element disposed in the common cladding 410 of the multicore optical fiber 400. The marker element 424 may be disposed in the common cladding 410 such that the first reference plane 420 may pass through the marker element 424. However, the marker element 424 may be disposed asymmetrically about the first reference plane 420.

In some embodiments, the marker element 424 may include a symmetrical cross-section. In some embodiments, the cross section of the marker element 424 may be symmetrical about a third reference plane 430 (also referred to as a plane of symmetry of the marker element 424) passing through a centerline 426 of the marker element 424. The centerline 426 of the marker element 424 may be offset and away from the first reference plane 420. In other words, the first reference plane 420 may not pass through the centerline 426 of the marker element 424. In some embodiments, the third reference plane 430 may further pass through the centerline 401 of the multicore optical fiber 400. Thus, the third reference plane 430 and the first reference plane 420 may intersect each other at the centerline 401 of the multicore optical fiber 400 and may be rotationally offset from each other about the centerline 401 of the multicore optical fiber 400. In some embodiments, the marker element 424 may include a circular cross section.

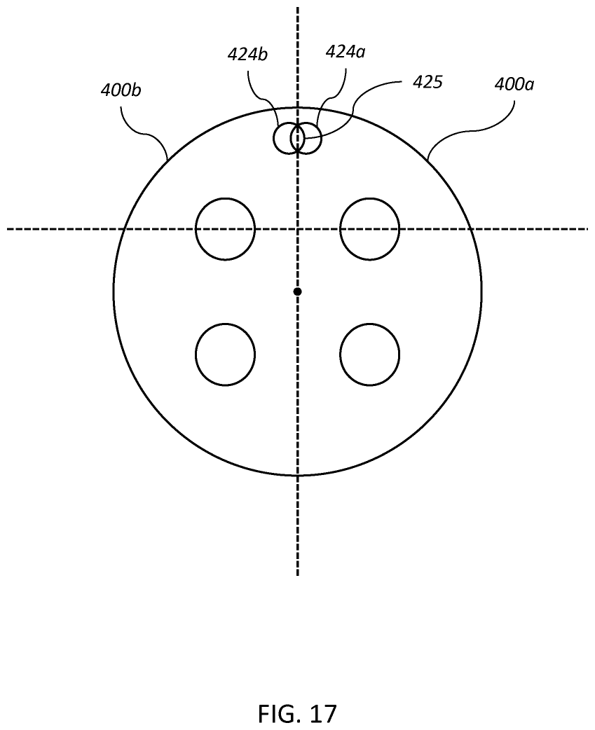

Similar to the marker element 124 described above, the asymmetrical disposition of the marker element 424 about the first reference plane 420 about which the core elements 402, 404, 406, 408 may be symmetrically disposed may allow identification or tracing of individual core elements 402, 404, 406, 408 at either ends of the multicore optical fiber 400. Further, since the marker element 424 may be only slightly offset from the first reference plane 420, when ends of the same handedness of two lengths of the multicore optical fiber 400a, 400b are spliced together as shown in FIG. 17, the marker elements 424a, 424b from the two lengths of the multicore optical fiber 400a, 400b may still have an area of overlap 425, which offers splicing flexibility as ends of either the same or opposite handedness may be spliced together without having to respooling or checking fiber directions for connectivity.

In some embodiments, the area of overlap 425 between the marker element 424a and the marker element 424b may be greater than or equal to (≥) 10%, ≥15%, ≥20%, ≥25%, ≥30%, ≥35%, ≥40%, ≥45%, ≥50%, ≥55%, ≥60%, ≥65%, ≥70%, ≥75%, ≥80%, ≥85%, or ≥90% of an entire cross-sectional area of the marker element 424a and/or the marker element 424b. In some embodiments, the area of overlap 425 between the marker element 424a and the marker element 424b may be less than or equal to (≤) 95%, ≤90%, ≤85%, ≤80%, ≤75%, ≤70%, ≤65%, ≤60%, ≤55%, ≤50%, ≤45%, ≤40%, ≤35%, ≤30%, ≤25%, ≤20%, or ≤15% of the entire cross-sectional area of the marker element 424a and/or the marker element 424b. In some embodiments, the area of overlap 425 between the marker element 424a and the marker element 424b may be greater than or equal to (i.e., ≥) 10% and less than or equal to (≤) 95% of the entire cross-sectional area of the marker element 424a and/or the marker element 424b—including all sub-ranges or values therebetween. For example, in some embodiments, the area of overlap 425 between the marker element 424a and the marker element 424b may be ≥10% and ≤95%, ≥10% and ≤60%, ≥10% and ≤35%, ≥35% and ≤95%, ≥35% and ≤60%, or ≥60% and ≤95% of the entire cross-sectional area of the marker element 424a and/or the marker element 424b. It should be noted that the area of overlap 425 described herein represents more than mere manufacturing variations so as to enable identification of the core elements 402, 404, 406, 408 from each other.

Referring back to FIG. 16, in some embodiments, the angle θ between the first reference plane 420 about which the core elements 402, 404, 406, 408 are symmetrically disposed and the third reference plane 430 (or the plane of symmetry 430 of the marker element 424) may be greater than or equal to (≥) 0.5°, ≥1°, ≥1.5°, ≥2°, ≥2.5°, ≥3°, ≥3.5°, ≥4°, ≥4.5°, ≥5°, ≥5.5°, ≥6°, ≥6.5°, ≥7°, ≥7.5°, ≥8°, ≥8.5°, ≥9°, ≥9.5° or greater. In some embodiments, the angle θ between the first reference plane 420 and the third reference plane 430 may be less than or equal to (≤) 10°, ≤9.5°, ≤9°, ≤8.5°, ≤8°, ≤7.5°, ≤7°, ≤6.5°, ≤6°, ≤5.5°, ≤5°, ≤4.5°, ≤4°, ≤3.5°, ≤3°, ≤2.5°, ≤2°, ≤1.5°, ≤1°, or less. In some embodiments, the angle θ between the first reference plane 420 and the third reference plane 430 may be greater than or equal to (i.e., ≥) 0.5° and less than or equal to (i.e., ≤) 10°—including all sub-ranges or values therebetween. For example, in some embodiments, the angle θ between the first reference plane 420 and the third reference plane 430 may be ≥0.5° and ≤10°, ≥0.5° and ≤8°, ≥0.5° and ≤6°, ≥0.5° and ≤4°, ≥0.5° and ≤2°, ≥2° and ≤10°, ≥2° and ≤8°, ≥2° and ≤6°, ≥2° and ≤4°, ≥4° and ≤10°, ≥4° and ≤8°, ≥4° and ≤6°, ≥6° and ≤10°, ≥6° and ≤8°, or ≥8° and ≤10°. The angle θ between the first reference plane 420 and the third reference plane 430 may also be referred to as the rotational offset between the first reference plane 420 and the third reference plane 430 about the centerline 401 of the multicore optical fiber 400. It should be noted that the angle θ between the first reference plane 420 and the third reference plane 430 described herein represents more than mere manufacturing variations so as to enable identification of the core elements 402, 404, 406, 408 from each other.

With continued reference to FIG. 16, a length 423 of the first reference plane 420 passing through the marker element 424 may be greater than or equal to (≥) 20%, ≥25%, ≥30%, ≥35%, ≥40%, ≥45%, ≥50%, ≥55%, ≥60%, ≥65%, ≥70%, ≥75%, ≥80%, ≥85%, ≥90%, or ≥95% of the diameter of the marker element 424. In some embodiments, the length 423 of the first reference plane 420 passing through the marker element 424 may be less than or equal to (≤) 99.8%, ≤95%, ≤90%, ≤85%, ≤80%, ≤75%, ≤70%, ≤65%, ≤60%, ≤55%, ≤50%, ≤45%, ≤40%, ≤35%, ≤30%, or ≤25% of the diameter of the marker element 424. In some embodiments, the length 423 of the first reference plane 420 passing through the marker element 424 may be greater than or equal to (i.e., ≥) 20% and less than or equal to (i.e., ≤) 99.8% of the diameter of the marker element 424—including all sub-ranges or values therebetween. For example, in some embodiments, the length 423 of the first reference plane 420 passing through the marker element 424 may be ≥20% and ≤99.8%, ≥20% and ≤80%, ≥20% and ≤60%, ≥20% and ≤40%, ≥40% and ≤99.8%, ≥40% and ≤80%, ≥40% and ≤60%, ≥60% and ≤99.8%, ≥60% and ≤80%, or ≥80% and ≤99.8% of the diameter of the marker element 424. It should be noted that the range of the length 423 described herein represents more than mere manufacturing variations so as to enable identification of the core elements 402, 404, 406, 408 from each other.

In some embodiments, the centerline 426 of the marker element 424 may be disposed in the common cladding 410 further away from the centerline 401 of the multicore optical fiber 400 than at least one or all of the centerlines 403, 405, 407, 409 of the core elements 402, 404, 406, 408. In some embodiments, the centerline 426 of the marker element 424 may be disposed in the common cladding 410 closer to the centerline 401 of the multicore optical fiber 400 than at least one or all of the centerlines 403, 405, 407, 409 of the core elements 402, 404, 406, 408. In some embodiments, the centerline 426 of the marker element 424 and at least one or all of the centerlines 403, 405, 407, 409 of the core elements 402, 404, 406, 408 may be disposed at the same radial distance from the centerline 401 of the multicore optical fiber 400.

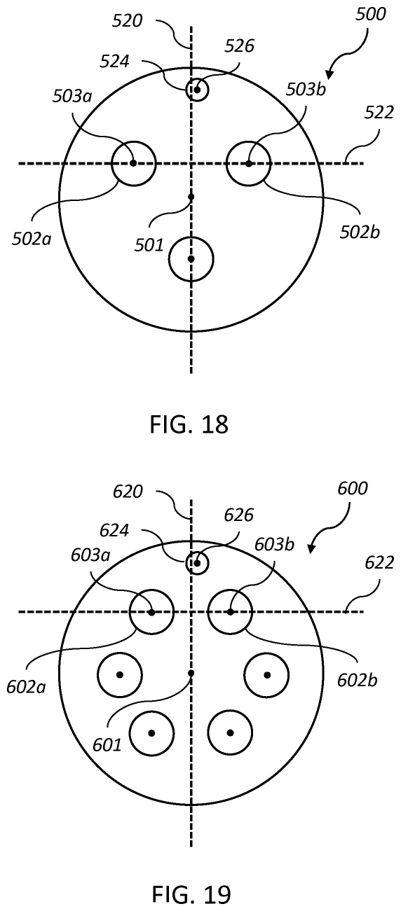

While two, three, and four core elements of various arrangements in the common cladding are described herein with reference to FIGS. 6-17, the multicore optical fiber may include any number of core elements that may be arranged symmetrically about a first reference plane (or plane of symmetry) passing through the centerline of the multicore optical fiber. Additional non-limiting examples are shown in FIGS. 18 and 19. A first reference plane 520, 620 about which the core elements 502, 602 may be symmetrically disposed may pass through the centerline 501, 601 of the multicore optical fiber 500, 600 without passing through the centerline 526, 626 of the marker element 524, 624. The first reference plane 520, 620 may be perpendicular to a second reference plane 522, 622 passing through the centerlines 503a, 503b, 603a, 603b of two nearest-neighbor core elements 502a, 502b, 602a, 602b. The offset disposition of the marker element 524, 624 may allow fiber ends having either the same or opposite handedness to be sliced together while maintaining the identification or traceability of individual core elements 502, 602.

Each of the core elements, the marker element, and/or the common cladding of the multicore optical fiber described herein may be formed from doped or undoped glass. Variations in refractive index are accomplished by incorporating updopants and/or downdopants at levels designed to provide a targeted refractive index. Updopants are dopants that increase the refractive index of the glass relative to the undoped glass composition. Downdopants are dopants that decrease the refractive index of the glass relative to the undoped glass composition. When the undoped glass is silica glass, updopants include Cl, Br, Ge, Al, P, Ti, Zr, Nb, Ta, etc., and downdopants include F, B, etc. Other dopants, such as alkali metals (e.g., Na, K), that have little effect on the refractive index of silica glass may also be included. A constant refractive index may be formed by not doping or by doping at a uniform concentration. A variable refractive index may be formed through non-uniform spatial distributions of dopants in a region and/or through incorporation of different dopants in different regions. The marker element may include a refractive index different from the refractive index of the common cladding of the multicore optical fiber described herein.

In some embodiments, a diameter of the common cladding of the multicore optical fiber described herein, which corresponds to the outer diameter of the glass fiber without any polymer coatings, may be greater than or equal to (≥) 50 μm. For example, in some embodiments, the diameter of the common cladding of the multicore optical fiber described herein may be ≥50 μm, ≥60 μm, ≥70 μm, ≥80 μm, ≥90 μm, ≥100 μm, ≥110 μm, ≥120 μm, ≥130 μm, ≥140 μm, ≥150 μm, ≥160 μm, ≥170 μm, ≥180 μm, ≥190 μm, ≥200 μm, ≥210 μm, ≥220 μm, ≥230 μm, ≥240 μm, or greater. In some embodiments, the diameter of the common cladding of the multicore optical fiber described herein may be less than or equal to (≤) 250 μm. For example, in some embodiments, the diameter of the common cladding of the multicore optical fiber described herein may be ≤250 μm, ≤240 μm, ≤230 μm, ≤220 μm, ≤210 μm, ≤200 μm, ≤190 μm, ≤180 μm, ≤170 μm, ≤160 μm, ≤150 μm, ≤140 μm, ≤130 μm, ≤120 μm, ≤110 μm, ≤100 μm, ≤90 μm, ≤80 μm, ≤70 μm, ≤60 μm, or less. In some embodiments, the diameter of the common cladding of the multicore optical fiber described herein may be greater than or equal to (i.e., ≥) 50 μm and less than or equal to (≤) 250 μm—including all sub-ranges or values therebetween. For example, in some embodiments, the diameter of the common cladding of the multicore optical fiber described herein may be ≥50 μm and ≤250 μm, ≥50 μm and ≤190 μm, ≥79 μm and ≤190 μm, ≥124 μm and ≤126 μm, or about 125 μm.

In some embodiments, the minimum core separation distance of the nearest neighboring core elements of the multicore optical fiber described herein may be greater than or equal to (i.e., ≥) 30 μm, ≥35 μm, ≥40 μm, ≥45 μm, ≥50 μm, ≥55 μm, ≥60 μm, or greater. In some embodiments, the minimum core separation distance of the nearest neighboring core elements of the multicore optical fiber described herein may be less than or equal to (i.e., ≤) 65 μm, ≤60 μm, ≤55 μm, ≤50 μm, ≤45 μm, ≤40 μm, ≤35 μm, or less.

In some embodiments, the radial distance between the centerline of the multicore optical fiber and the centerline of a core element may be greater than or equal to (≥) 10 μm, ≥15 μm, ≥20 μm, ≥25 μm, ≥30 μm, ≥35 μm, ≥40 μm, ≥45 μm, ≥50 μm, ≥55 μm, ≥60 μm, ≥65 μm, ≥70 μm, ≥75 μm, ≥80 μm, ≥85 μm, ≥90 μm, ≥95 μm, or greater. In some embodiments, the radial distance between the centerline of the multicore optical fiber and the centerline of a core element may be less than or equal to (≤) 100 μm, ≤95 μm, ≤90 μm, ≤85 μm, ≤80 μm, ≤75 μm, ≤70 μm, ≤65 μm, ≤60 μm, ≤55 μm, ≤50 μm, ≤45 μm, ≤40 μm, ≤35 μm, ≤30 μm, ≤25 μm, ≤20 μm, ≤15 μm, or less. In some embodiments, the radial distance between the centerline of the multicore optical fiber and the centerline of a core element may be greater than or equal to (i.e., ≥) 10 μm and less than or equal to (i.e., ≤) 100 μm—including all sub-ranges or values therebetween. For example, in some embodiments, the radial distance between the centerline of the multicore optical fiber and the centerline of a core element may be ≥10 μm and ≤100 μm, ≥10 μm and ≤70 μm, ≥10 μm and ≤40 μm, ≥40 μm and ≤100 μm, ≥40 μm and ≤70 μm, or ≥70 μm and ≤100 μm. The core elements within a multicore optical fiber may include the same radius or different radii in various embodiments.

In embodiments where the multicore optical fiber includes two core elements, including but not limited to the examples shown in FIGS. 6, 13A, and 13B, the radial distance between the centerline of the multicore optical fiber and the centerline of a core element may be greater than or equal to (i.e., ≥) 18 μm, ≥20 μm, ≥22 μm, ≥24 μm, ≥26 μm, ≥28 μm, ≥30 μm, ≥32 μm, ≥34 μm, or greater. In some embodiments, the radial distance between the centerline of the multicore optical fiber and the centerline of a core element may be less than or equal to (i.e., ≤) 35 μm, ≤33 μm, ≤31 μm, ≤29 μm, ≤27 μm, ≤25 μm, ≤23 μm, ≤21 μm, ≤19 μm, ≤17 μm, or less. In some embodiments, the radial distance between the centerline of the multicore optical fiber and the centerline of a core element may be greater than or equal to (i.e., ≥) 18 μm and less than or equal to (i.e., ≤) 35 μm—including all sub-ranges or values therebetween. For example, in some embodiments, the radial distance between the centerline of the multicore optical fiber and the centerline of a core element may be ≥18 μm and ≤35 μm, ≥18 μm and ≤31 μm, ≥18 μm and ≤27 μm, ≥18 μm and ≤23 μm, ≥23 μm and ≤35 μm, ≥23 μm and ≤31 μm, ≥23 μm and ≤27 μm, ≥27 μm and ≤35 μm, ≥27 μm and ≤31 μm, or ≥31 μm and ≤35 μm.

In embodiments where the multicore optical fiber includes four core elements in a 1×4 arrangement, including but not limited to the example shown in FIG. 15, the radial distance between the centerline of the multicore optical fiber and the centerline of a core element may be greater than or equal to (i.e., ≥) 12.5 μm, ≥15 μm, ≥17.5 μm, ≥20 μm, ≥22.5 μm, ≥25 μm, ≥27.5 μm, ≥30 μm, ≥32.5 μm, ≥35 μm, ≥37.5 μm, ≥40 μm, ≥42.5 μm, or greater. In some embodiments, the radial distance between the centerline of the multicore optical fiber and the centerline of a core element may be less than or equal to (i.e., ≤) 45 μm, ≤42.5 μm, ≤40 μm, ≤37.5 μm, ≤35 μm, ≤32.5 μm, ≤30 μm, ≤27.5 μm, ≤25 μm, ≤22.5 μm, ≤20 μm, ≤17.5 μm, ≤15 μm, or less. In some embodiments, the radial distance between the centerline of the multicore optical fiber and the centerline of a core element may be greater than or equal to (i.e., ≥) 12.5 μm and less than or equal to (i.e., ≤) 45 μm—including all sub-ranges or values therebetween. For example, in some embodiments, the radial distance between the centerline of the multicore optical fiber and the centerline of a core element may be ≥12.5 μm and ≤45 μm, ≥12.5 μm and ≤40 μm, ≥12.5 μm and ≤35 μm, ≥12.5 μm and ≤30 μm, ≥12.5 μm and ≤25 μm, ≥12.5 μm and ≤20 μm, ≥12.5 μm and ≤15 μm, ≥15 μm and ≤45 μm, ≥15 μm and ≤40 μm, ≥15 μm and ≤35 μm, ≥15 μm and ≤30 μm, ≥15 μm and ≤25 μm, ≥15 μm and ≤20 μm, ≥20 μm and ≤45 μm, ≥20 μm and ≤40 μm, ≥20 μm and ≤35 μm, ≥20 μm and ≤30 μm, ≥20 μm and ≤25 μm, ≥25 μm and ≤45 μm, ≥25 μm and ≤40 μm, ≥25 μm and ≤35 μm, ≥25 μm and ≤30 μm, ≥30 μm and ≤45 μm, ≥30 μm and ≤40 μm, ≥30 μm and ≤35 μm, ≥35 μm and ≤45 μm, ≥35 μm and ≤40 μm, or ≥40 μm and ≤45 μm.

In embodiments where the multicore optical fiber includes four core elements in a 2×2 arrangement, including but not limited to the example shown in FIG. 16, the radial distance between the centerline of the multicore optical fiber and the centerline of a core element may be greater than or equal to (i.e., ≥) 25 μm, ≥26 μm, ≥27 μm, ≥28 μm, ≥29 μm, ≥30μ, ≥31 μm, ≥32 μm, ≥33 μm, ≥34 μm, or greater. In some embodiments, the radial distance between the centerline of the multicore optical fiber and the centerline of a core element may be ≤35 μm, ≤34 μm, ≤33 μm, ≤32 μm, ≤31 μm, ≤30 μm, ≤29 μm, ≤28 μm, ≤27 μm, ≤26 μm, or less. In some embodiments, the radial distance between the centerline of the multicore optical fiber and the centerline of a core element may be greater than or equal to (i.e., ≥) 25 μm and less than or equal to (i.e., ≤) 35 μm—including all sub-ranges or values therebetween. For example, in some embodiments, the radial distance between the centerline of the multicore optical fiber and the centerline of a core element may be ≥25 μm and ≤35 μm, ≥25 μm and ≤32.5 μm, ≥25 μm and ≤30 μm, ≥25 μm and ≤27.5 μm, ≥27.5 μm and ≤35 μm, ≥27.5 μm and ≤32.5 μm, ≥27.5 μm and ≤30 μm, ≥30 μm and ≤35 μm, ≥30 μm and ≤32.5 μm, or ≥32.5 μm and ≤35 μm.

In some embodiments, the radial distance between the centerline of the multicore optical fiber and the centerline of the marker element may be greater than or equal to (≥) 10 μm, ≥20 μm, ≥30 μm, ≥40 μm, ≥50 μm, ≥60 μm, ≥70 μm, ≥80 μm, ≥90 μm, ≥100 μm, ≥110 μm, or greater. In some embodiments, the radial distance between the centerline of the multicore optical fiber and the centerline of the marker element may be less than or equal to (≤) 120 μm, ≤110 μm, ≤100 μm, ≤90 μm, ≤80 μm, ≤70 μm, ≤60 μm, ≤50 μm, ≤40 μm, ≤30 μm, ≤20 μm, or less. In some embodiments, the radial distance between the centerline of the multicore optical fiber and the centerline of the marker element may be greater than or equal to (i.e., ≥) 10 μm and less than or equal to (i.e., ≤) 120 μm—including all sub-ranges or values therebetween. For example, in some embodiments, the radial distance between the centerline of the multicore optical fiber and the centerline of the marker element may be ≥10 μm and ≤120 μm, ≥10 μm and ≤90 μm, ≥10 μm and ≤60 μm, ≥10 μm and ≤30 μm, ≥30 μm and ≤120 μm, ≥30 μm and ≤90 μm, ≥30 μm and ≤60 μm, ≥60 μm and ≤120 μm, ≥60 μm and ≤90 μm, or ≥90 μm and ≤120 μm.

In embodiments where the multicore optical fiber includes two core elements, including but not limited to the examples shown in FIGS. 6, 13A, and 13B, the radial distance between the centerline of the multicore optical fiber and the centerline of the marker element may be greater than or equal to (i.e., ≥) 10 μm, ≥15 μm, ≥20 μm, ≥25 μm, ≥30 μm, ≥35 μm, ≥40 μm, ≥45 μm, ≥50 μm, ≥55 μm, or greater. In some embodiments, the radial distance between the centerline of the multicore optical fiber and the centerline of the marker element may be less than or equal to (i.e., ≤) 60 μm, ≤55 μm, ≤50 μm, ≤45 μm, ≤40 μm, ≤35 μm, ≤30 μm, ≤25 μm, ≤20 μm, ≤15 μm, or less. In some embodiments, the radial distance between the centerline of the multicore optical fiber and the centerline of the marker element may be greater than or equal to (i.e., ≥) 10 μm and less than or equal to (i.e., ≤) 60 μm—including all sub-ranges or values therebetween. For example, in some embodiments, the radial distance between the centerline of the multicore optical fiber and the centerline of the marker element may be ≥10 μm and ≤60 μm, ≥10 μm and ≤50 μm, ≥10 μm and ≤40 μm, ≥10 μm and ≤30 μm, ≥10 μm and ≤20 μm, ≥20 μm and ≤60 μm, ≥20 μm and ≤50 μm, ≥20 μm and ≤40 μm, ≥20 μm and ≤30 μm, ≥30 μm and ≤60 μm, ≥30 μm and ≤50 μm, ≥30 μm and ≤40 μm, ≥40 μm and ≤60 μm, ≥40 μm and ≤50 μm, or ≥50 μm and ≤60 μm.

In embodiments where the multicore optical fiber includes four core elements in 1×4 or 2×2 arrangement, including but not limited to the example shown in FIGS. 15 and 16, the radial distance between the centerline of the multicore optical fiber and the centerline of the marker element may be greater than or equal to (i.e., ≥) 10 μm, ≥15 μm, ≥20 μm, ≥25 μm, ≥30 μm, ≥35 μm, ≥40 μm, ≥45 μm, ≥50 μm, ≥55 μm, or greater. In some embodiments, the radial distance between the centerline of the multicore optical fiber and the centerline of the marker element may be less than or equal to (i.e., ≤) 60 μm, ≤55 μm, ≤50 μm, ≤45 μm, ≤40 μm, ≤35 μm, ≤30 μm, ≤25 μm, ≤20 μm, ≤15 μm, or less. In some embodiments, the radial distance between the centerline of the multicore optical fiber and the centerline of the marker element may be greater than or equal to (i.e., ≥) 10 μm and less than or equal to (i.e., ≤) 60 μm—including all sub-ranges or values therebetween. For example, in some embodiments, the radial distance between the centerline of the multicore optical fiber and the centerline of the marker element may be ≥10 μm and ≤60 μm, ≥10 μm and ≤50 μm, ≥10 μm and ≤40 μm, ≥10 μm and ≤30 μm, ≥10 μm and ≤20 μm, ≥20 μm and ≤60 μm, ≥20 μm and ≤50 μm, ≥20 μm and ≤40 μm, ≥20 μm and ≤30 μm, ≥30 μm and ≤60 μm, ≥30 μm and ≤50 μm, ≥30 μm and ≤40 μm, ≥40 μm and ≤60 μm, ≥40 μm and ≤50 μm, or ≥50 μm and ≤60 μm.

In some embodiments, the diameter of the marker element described herein may be less than the mode field diameter (MFD) of at least one or all of the core elements of the multicore optical fiber described herein as measured at a wavelength of 1310 nm. In some embodiments, the diameter of the marker element described herein may be greater than or equal to (i.e., ≥) ⅓ of the mode field diameter (MFD) of at least one or all of the core elements of the multicore optical fiber described herein as measured at a wavelength of 1310 nm. In some embodiments, the diameter of the marker element described herein may be less than or equal to (i.e., ≤) ½ of the mode field diameter (MFD) of at least one or all of the core elements of the multicore optical fiber described herein as measured at a wavelength of 1310 nm. In some embodiments, the diameter of the marker element described herein may be greater than or equal to (i.e., ≥) ⅓ and less than or equal to (i.e., ≤) ½—including all sub-ranges or values therebetween—of the mode field diameter (MFD) of at least one or all of the core elements of the multicore optical fiber described herein as measured at a wavelength of 1310 nm.

The various multicore optical fibers described herein can be made using any suitable method for forming a multicore optical fiber. See, for example, U.S. Pat. No. 11,370,689, the entire content of which is incorporated herein by reference. An exemplary method that is used to form the multicore optical fiber described herein includes forming a glass blank for the common cladding. Formation of the glass blank may involve first forming a soot body which is then dehydrated and consolidated to fully densified glass. Multiple holes are then drilled along the length of the glass blanks for two or more core canes and a marker cane to be inserted therein. After each core cane and the marker cane is inserted into the glass blank, the fiber preform is assembled by thermally closing the gap between the inserted canes and the drilled holes. The assembled preform is then drawn into a multicore optical fiber. In a continuous optical fiber manufacturing process, a glass fiber is drawn from a heated preform and sized to a target diameter. The glass fiber is then cooled at a controlled rate and directed to a coating system that applies a liquid coating compositions to the glass fiber. After the fiber exits the coating system, the fiber is collected and stored at room temperature. Collection of the fiber typically entails winding the fiber on a spool and storing the spool. Fluid bearing devices may be used to turn and redirect the optical fiber during the draw process.

The present disclosure provides multicore optical fibers, as well as ribbons and cables containing the multicore optical fibers described herein. In a ribbon, two or more multicore optical fibers are aligned relative to one another in a substantially planar and parallel relationship. The multicore optical fibers in ribbons are encapsulated by a ribbon matrix. A cable includes two or more multicore optical fibers surrounded by a jacket. The jacket typically has a circular cross-section and is flexible or rigid depending on the application requirement. Multicore optical fibers are densely or loosely packed into a conduit enclosed by an inner surface of the jacket. The jacket is formed from an extruded polymer material and may include multiple concentric layers of polymers or other materials. The cable may also include one or more strengthening members embedded within the jacket or placed within the conduit defined by the inner surface of the jacket. Strengthening members include fibers or rods that are more rigid than the jacket. The strengthening member is made from metal, braided steel, glass-reinforced plastic, fiber glass, or other suitable material. The cable may include other layers surrounded by the jacket (e.g., armor layers, moisture barrier layers, rip cords, etc.). The cable may have a stranded, loose tube core or other fiber optic cable construction.

It will be apparent to those skilled in the art that various modifications and variations can be made without departing from the spirit or scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A multicore optical fiber, comprising:
a first core element;
a second core element; and
a marker element;
wherein:
the first core element and the second core element are disposed symmetrically on either side of a reference plane passing through a centerline of the multicore optical fiber and passing through the marker element; and
the marker element is disposed asymmetrically about the reference plane.

2. The multicore optical fiber of claim, wherein:
the reference plane is a first reference plane;
a centerline of the first core element and a centerline of the second core element are disposed on a second reference plane; and
the first reference plane is perpendicular to the second reference plane.

3. The multicore optical fiber of claim, wherein:
the multicore optical fiber comprises a plurality of core elements;
the plurality of core elements comprises the first core element and the second core element; and
a distance between a centerline of the first core element and a centerline of the second core element is less than or equal to a distance between centerlines of any two core elements of the plurality of core elements.

4. The multicore optical fiber of claim, wherein the plurality of core elements is disposed symmetrically about the reference plane.

5. The multicore optical fiber of claim, wherein the reference plane does not pass through a centerline of the marker element.

6. The multicore optical fiber of claim, wherein the marker element comprises a plane of symmetry passing through the centerline of the multicore optical fiber, and wherein an angle between the plane of symmetry of the marker element and the reference plane about which the first core element and the second core element are symmetrically disposed is greater than or equal to 0.5° and/or less than or equal to 10°.

7. The multicore optical fiber of claim, wherein the marker element comprises a circular cross section.

8. The multicore optical fiber of claim, wherein the length of the reference plane passing through the marker element is less than or equal to 99.8% of the diameter of the marker element and/or greater than or equal to 20% of the diameter of the marker element.

9. The multicore optical fiber of claim, wherein the marker element satisfies at least one of the following:
wherein a diameter of the marker element is less than a mode field diameter (MFD) of at least one or each of the first core element or the second core element measured at a wavelength of 1310 nm;
wherein the diameter of the marker element is greater than or equal to ⅓ of the mode field diameter (MFD) of the at least one or each of the first core element or the second core element measured at a wavelength of 1310 nm; and/or
wherein the diameter of the marker element is less than or equal to ½ of the mode field diameter (MFD) of the at least one or each of the first core element or the second core element measured at a wavelength of 1310 nm.

10. The multicore optical fiber of claim, further comprising a common cladding surrounding and contacting the first core element and the second core element, wherein the marker element is the only marker element disposed in the common cladding.

11. The multicore optical fiber of claim, wherein a refractive index of the marker element is different from a refractive index of the common cladding.

12. A multicore optical fiber, comprising:
a first end;
a second end opposite the first end;
a length between the first end and the second end;
a first core element extending along the length of the multicore optical fiber from the first end to the second end;
a second core element extending along the length of the multicore optical fiber from the first end to the second end; and
a marker element;
wherein:
the first end defines a first cross section of the multicore optical fiber;
the second end defines a second cross section of the multicore optical fiber; and
the first core element, the second core element, and the marker element are configured such that when the second cross section is superimposed on the first cross section with a centerline of a first cross-sectional shape of the first core element from the first cross section being aligned with a centerline of a second cross-sectional shape of the second core element from the second cross section, a third cross-sectional shape of the marker element from the first cross section partially overlaps with and is offset from a fourth cross-sectional shape of the marker element from the second cross section.

13. The multicore optical fiber of claim, a distance between a centerline of the first core element and a centerline of the second core element at the first end is less than or equal to a distance between centerlines of any two core elements of the multicore optical fiber at the first end.

14. The multicore optical fiber of claim of, wherein an area of the third cross-sectional shape of the marker element from the first cross section that overlaps with the fourth cross-sectional shape of the marker element from the second cross section is greater than or equal to 10% of an entire area of the third cross-sectional shape.

15. The multicore optical fiber of claim of, wherein an area of the third cross-sectional shape of the marker element from the first cross section that overlaps with the fourth cross-sectional shape of the marker element from the second cross section is less than or equal to 95% of an entire area of the third cross-sectional shape.

16. The multicore optical fiber of claim, wherein:
the marker element comprises a circular cross section;
the first core element and the second core element are disposed symmetrically on either side of a reference plane passing through a centerline of the multicore optical fiber and passing through the marker element; and
a length of the reference plane passing through the marker element is less than a diameter of the marker element.

17. The multicore optical fiber of claim, wherein the length of the reference plane passing through the marker element is less than or equal to 99.8% of the diameter of the marker element and/or greater than or equal to 20% of the diameter of the marker element.

18. A multicore optical fiber, comprising:
a first end;
a second end opposite the first end;
a length between the first end and the second end;
a core element extending along the length of the multicore optical fiber from the first end to the second end;
a marker element; and
a common cladding surrounding and contacting the core element and the marker element;
wherein:
the first end defines a first cross section of the multicore optical fiber;
the second end defines a second cross section of the multicore optical fiber; and
the core element and the marker element are configured such that when the second cross section is superimposed on the first cross section with a centerline of a first cross-sectional shape of the marker element from the first cross section being aligned with a centerline of a second cross-sectional shape of the marker element from the second cross section, a third cross-sectional shape of the core element from the first cross section partially overlaps with and is offset from a fourth cross-sectional shape of the core element from the second cross section.

19. The multicore optical fiber of claim, wherein an area of overlap between the third cross-sectional shape of the core element from the first cross section and the fourth cross-sectional shape of the core element from the second cross section is less than or equal to 95% of an entire area of the third cross-sectional shape of the core element.

20. The multicore optical fiber of claim, wherein an area of overlap between the third cross-sectional shape of the core element from the first cross section and the fourth cross-sectional shape of the core element from the second cross section is greater than or equal to 10% of an entire area of the third cross-sectional shape of the core element.
